(19) United States
(12) Patent Application Publication
(10) Pub. No.: US 2026/0289124 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/565,626

(22) Filed: Mar. 13, 2026

(30) Foreign Application Priority Data
Mar. 19, 2025 (JP) 2025-045154

(51) Int. Cl. G06F 40/284; G06F 40/205; G06Q 30/0601

(52) U.S. Cl. CPC G06F 40/284; G06F 40/205; G06Q 30/06432

(57) ABSTRACT

A system includes a processor that is configured to acquire hot-selling information from a specific database, generate a prompt for instructing performance of fashion recommendation through interaction with a user based on the hot-selling information, generate a prompt for instructing customization of recommendation content based on a preference and a body type of the user by using a generative artificial intelligence model, and generate a prompt for instructing adjustment of the recommendation based on an emotion of the user recognized from input obtained from the user.

### CROSS-REFERENCE TO RELATED APPLICATION

This application is based on and claims priority under 35 USC 119 from Japanese Patent Application No. 2025-045154 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional fashion recommendation systems mainly rely on static rules, simple filtering, or basic statistical popularity metrics, and therefore cannot flexibly provide proposals that are simultaneously aligned with real-time hot-selling trends, individual user preferences, and individual body types. Furthermore, conventional systems generally do not utilize generative artificial intelligence models to dynamically customize recommendation content, and they lack a mechanism for recognizing a user's emotional state and adapting recommendations in response to that state. As a result, the user often receives recommendations that feel generic, impersonal, or inappropriate to the user's current mood, leading to reduced satisfaction and a lower likelihood of purchase or continued engagement. Accordingly, there is a need for a system that can (i) acquire hot-selling information from a specific database, (ii) generate prompts to instruct interaction-based fashion recommendations, (iii) generate prompts for customization of recommendation content using a generative artificial intelligence model based on the user's preference and body type, and (iv) generate prompts for adjusting the recommendations according to a recognized emotion of the user, thereby improving relevance, personalization, and user experience.

### SUMMARY

In order to solve the above problems, a system is provided comprising a processor, wherein the processor is configured to acquire hot-selling information from a specific database and generate a prompt for instructing performance of fashion recommendation through interaction with a user based on the acquired hot-selling information. The processor is further configured to generate a prompt for instructing customization of recommendation content based on a preference and a body type of the user by using a generative artificial intelligence model, so that the recommendation content can be dynamically tailored to each individual user. In addition, the processor is configured to generate a prompt for instructing adjustment of the recommendation based on an emotion of the user recognized from input obtained from the user, thereby enabling the system to adapt the recommendation to the user's emotional state. In some embodiments, the processor is configured to acquire the hot-selling information from the specific database by retrieving fashion-related product information and sales information and generating the hot-selling information based on the retrieved information, and to customize proposed fashion items according to the preference and the body type of the user and cause the customized fashion items to be displayed in real time.

The term “system” refers to an arrangement comprising at least one processor and, optionally, one or more memories, communication interfaces, input/output devices, and external databases, which cooperate to execute the processing described in the present specification and claims.

The term “processor” refers to a hardware processing unit, such as a central processing unit (CPU), a graphics processing unit (GPU), an application specific integrated circuit (ASIC), a field programmable gate array (FPGA), or any combination thereof, that executes instructions to perform the functions described in the present specification and claims.

The term “hot-selling information” refers to information indicating popularity of fashion-related items, generated on the basis of fashion-related product information and sales information, such as sales volume, sales ranking, or return rate, obtained from a specific database.

The term “specific database” refers to a database, which may be local or remote, that stores fashion-related product information and sales information, and from which data is retrieved in order to generate the hot-selling information used by the system.

The term “prompt” refers to data, including a text string, structured information, or parameters, that is provided as input to a generative artificial intelligence model or another processing module, and that instructs or conditions generation of an output such as a fashion recommendation, a customization result, or an adjustment based on user emotion.

The term “fashion recommendation” refers to a proposal of one or more fashion items, outfits, or combinations thereof that are suggested to a user based on hot-selling information, user preferences, user body type, user emotion, or any combination of these factors.

The term “interaction with a user” refers to an exchange of information between the system and the user, carried out via a terminal or user interface, in which the user provides input such as preferences, feedback, or emotional expressions, and the system provides outputs such as questions, recommendations, or updated proposals.

The term “generative artificial intelligence model” refers to a machine learning model, such as a generative language model, a generative adversarial network, a diffusion model, or another generative model, that generates content including text, images, or structured data in response to a given prompt or input condition.

The term “preference of the user” refers to information representing likes, dislikes, or desired conditions of the user regarding fashion, including but not limited to style, color, budget, usage scene, or brand preference.

The term “body type of the user” refers to information describing physical characteristics of the user relevant to fashion selection, such as height, weight, body shape, size, proportions, or other measurements.

The term “emotion of the user” refers to a psychological or affective state of the user, such as happiness, sadness, excitement, frustration, or neutrality, which is recognized by the system based on input obtained from the user, including textual input, voice input, facial expressions, or interaction patterns.

The term “proposed fashion items” refers to specific fashion products, such as clothing, shoes, or accessories, that the system has selected and output as part of a fashion recommendation for the user.

The term “customize” refers to modifying, selecting, or arranging one or more attributes of proposed fashion items, such as size, color, style, combination, or fit, in accordance with the user's preference and body type.

The term “real time” refers to processing and display that are performed with a responsiveness sufficient for the user to perceive the system reaction as substantially immediate during ongoing interaction, without a noticeable delay that would interrupt the user experience.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

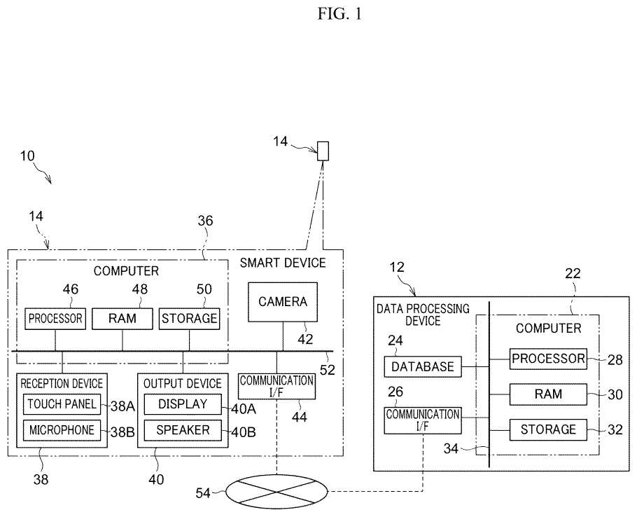

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

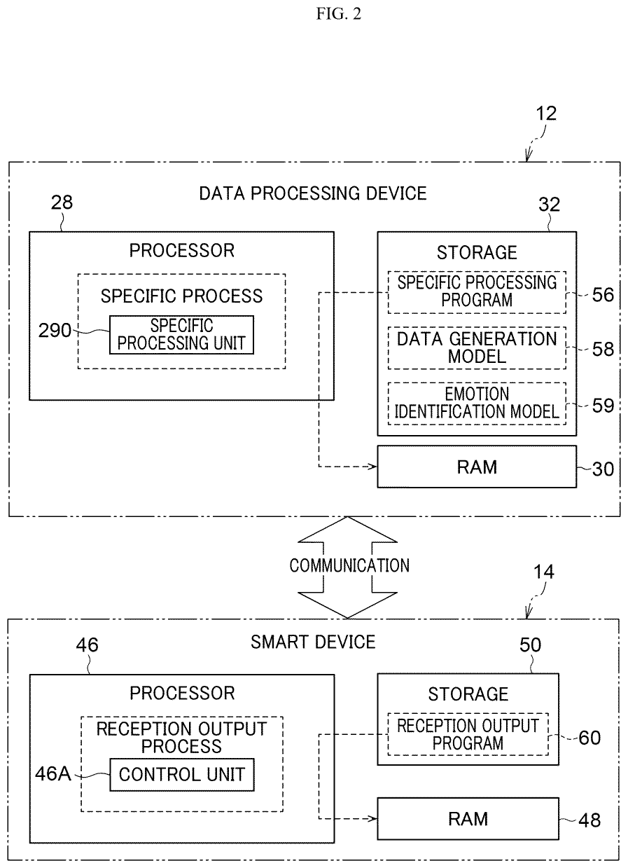

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recommendation systems for fashion or other consumer products suffer from several technical limitations in the way they acquire, process, and utilize large-scale sales data and user interaction data. First, many systems rely on static rule-based engines or simple filtering of sales rankings, which do not dynamically integrate up-to-date distribution trend information with fine-grained user attributes and preferences. As a result, such systems typically perform separate, sequential processing steps for data retrieval, recommendation generation, and user interface rendering, causing redundant data transfers, increased computation time, and inefficient use of processing resources.

Second, known systems generally treat user-facing prompts and internal model inputs as ad hoc text or isolated parameters. They do not provide a systematic mechanism for generating, updating, and reusing structured prompt sentences and numerical feature information as unified inputs to a generative artificial intelligence model. This limits the model's ability to exploit the full context of merchandise trends and user states, and leads to suboptimal utilization of the model's inference capabilities and the underlying hardware, such as central processing units and graphics processing units.

Third, existing architectures often lack a feedback loop that efficiently incorporates iterative user modifications and emotional state information into the recommendation process at the system level. User refinements and emotional responses are frequently handled only at the presentation layer, without being fed back as first-class signals into the data processing pipeline and the generative artificial intelligence model. This absence of integrated, low-latency feedback results in additional network round-trips, repeated computation on stale data, and degraded responsiveness of the user interface.

Fourth, in many implementations, sales information is retrieved from storage as raw records on a per-request basis and processed individually for each recommendation query. This approach does not make effective use of tabular in-memory representations, aggregation operations, or caching mechanisms, causing unnecessary load on data management resources and increasing latency in generating recommendations, particularly when handling large volumes of sales data and concurrent user sessions.

Accordingly, there is a need for an improved computer-implemented system and server that technically enhance the way merchandise information, user attribute and preference information, prompt sentences for a generative artificial intelligence model, and user emotional state information are processed and combined. The system should reduce redundant data processing, enable efficient generation and regeneration of recommendation candidates, and improve real-time responsiveness and stability of the overall computing environment by optimizing the interaction between the processor, storage resources, communication interfaces, and the generative artificial intelligence model.

The specific processing by the specific processing unit 290 of the data processing device 12 in Example 1 is realized by the following means.

The present invention provides a server comprising a processor configured to acquire merchandise information including sales information from a storage information source, to perform numerical processing and statistical processing on the acquired merchandise information to generate distribution trend information as tabular data maintained in a main storage apparatus, to receive input information including user attribute information and user preference information from a terminal device and convert the input information into structured information, to generate, based on the distribution trend information and the structured information, a prompt sentence expressed in a natural language and numerical feature information as unified inputs for a generative artificial intelligence model, to input the prompt sentence and the numerical feature information to the generative artificial intelligence model and obtain relevance information and proposal content information from the generative artificial intelligence model, to select and rank merchandise information based on the relevance information to generate proposal candidate information, to acquire image information corresponding to the proposal candidate information from an image storage device and generate display information including the proposal candidate information and the image information, to transmit the display information to the terminal device so as to cause the terminal device to perform visual display, to update the structured information based on change request information and state information relating to an emotional state of a user acquired from the terminal device, and to regenerate the prompt sentence, the numerical feature information, and the proposal candidate information by causing the generative artificial intelligence model to perform re-inference processing based on the updated structured information and the distribution trend information. This enables technical improvement of the computer system by reducing redundant access to the storage information source, optimizing in-memory tabular processing of sales data, unifying natural language prompt generation and numerical feature generation for efficient inference by the generative artificial intelligence model, and providing a low-latency feedback loop that adaptively updates recommendation results and display information based on iterative user operations and emotional state, thereby enhancing processing efficiency, responsiveness, and resource utilization in the server and the terminal device.

The term “processor” refers to a hardware or hardware-implemented processing unit, such as a central processing unit or a graphics processing unit, configured to execute instructions and perform arithmetic, logical, control, and input/output operations to implement functions of the system.

The term “storage information source” refers to a data storage apparatus or data management system, such as a database system or a file storage system, configured to store merchandise information including sales information so that the processor can retrieve the merchandise information.

The term “merchandise information” refers to digital data representing one or more items offered for sale, including attributes such as identifiers, categories, prices, sales quantities, and other descriptive or transactional attributes.

The term “sales information” refers to a subset of the merchandise information that includes data representing transaction results, such as sales quantities, sales amounts, sales timestamps, and related metrics for the merchandise.

The term “numerical processing” refers to operations performed by the processor on numeric data, including calculations such as addition, subtraction, multiplication, division, weighting, scoring, normalization, and similar arithmetic operations.

The term “statistical processing” refers to operations performed by the processor to compute statistical values, such as sums, averages, counts, variances, rankings, and distributions, based on sales information or other numerical data.

The term “distribution trend information” refers to data generated by the processor that represents trends or tendencies in the circulation, sales, or popularity of merchandise over time, derived from sales information and other related data.

The term “main storage apparatus” refers to a volatile memory device, such as a random access memory, in which tabular data and intermediate processing results are held for access and manipulation by the processor.

The term “tabular data” refers to data structured in a table-like format, including rows and columns, where each column represents a particular attribute and each row represents an instance or record of merchandise or related information.

The term “terminal device” refers to an information processing device, such as a personal computer, a smartphone, a tablet, or another client device, that communicates with the server and provides a user interface for input and display.

The term “input information” refers to digital data transmitted from the terminal device to the server, including user attribute information, user preference information, and other user-provided parameters.

The term “user attribute information” refers to data representing characteristics of a user, such as body type, demographic attributes, and other profile-related information.

The term “user preference information” refers to data representing user choices or likes, such as preferred style, color, category, budget, and other desired conditions for merchandise.

The term “structured information” refers to information that has been converted by the processor into a predefined data structure, such as a record, a list, or a key-value set, suitable for systematic processing and model input.

The term “communication path” refers to a logical or physical communication channel, including wired or wireless networks, over which the server and the terminal device exchange digital information.

The term “prompt sentence” refers to a sequence of natural language characters or tokens generated by the processor for input to a generative artificial intelligence model, the sequence describing conditions or instructions for producing recommendation results.

The term “generative artificial intelligence model” refers to a software-implemented inference engine that has been trained on data and is configured to generate outputs, such as relevance information or proposal content information, based on input including a prompt sentence and numerical feature information.

The term “numerical feature information” refers to numeric representations of attributes, preferences, and other contextual data, such as encoded vectors or feature values, which are provided as input to the generative artificial intelligence model together with or in addition to the prompt sentence.

The term “relevance information” refers to output data from the generative artificial intelligence model indicating degrees of correspondence or matching between merchandise information and the input information, such as scores or ranking indicators.

The term “proposal content information” refers to output data from the generative artificial intelligence model describing recommended merchandise or proposal details, including item selections, descriptions, or combinations suggested for the user.

The term “proposal candidate information” refers to information generated by the processor by selecting and ranking merchandise information based on relevance information, the information representing one or more candidate items to be proposed to the user.

The term “image information” refers to digital data identifying or representing images associated with merchandise, including image identifiers, file paths, or encoded image content.

The term “image storage device” refers to a storage apparatus or service configured to store image information, such as an image file repository, an object storage system, or a media database.

The term “display information” refers to data generated by the processor for presentation on the terminal device, including proposal candidate information, image information, and layout-related metadata used to render a visual interface.

The term “change request information” refers to information transmitted from the terminal device that indicates modifications requested by the user to previously proposed merchandise, including adjustments to preferences, constraints, or specific items.

The term “state information relating to an emotional state of the user” refers to information obtained from the terminal device that represents or estimates the emotional state of the user, such as satisfaction, dissatisfaction, interest, or disinterest, derived from explicit input, behavioral signals, or sensor data.

The term “re-inference processing” refers to a process in which the generative artificial intelligence model is executed again using updated prompt sentences and numerical feature information to generate new or updated recommendation outputs.

The term “user display screen” refers to a graphical user interface rendered by the terminal device, including one or more regions for displaying proposal candidate information and for receiving user attribute information, user preference information, and change request information.

The term “real-time display processing” refers to processing in which the terminal device updates the visual display of proposal candidate information substantially immediately in response to updated display information received from the server, within a latency that is not perceptible as a delay to a human user in normal use.

In one embodiment, a server includes a processor, a main memory, a non-volatile storage device, and a communication interface connected to a network. The server runs an operating system such as a general-purpose server operating system, a database management system, and an application layer including a recommendation engine and a generative AI model inference engine. A terminal includes a processor, a display device, an input device such as a touch panel or keyboard, a memory, and a communication interface. A user operates the terminal to interact with the server through a network connection.

The server stores merchandise information, including sales information, in a storage information source implemented as a relational database management system or a key-value store. The server manages tables in which each row corresponds to merchandise and each column corresponds to attributes such as item identifier, category identifier, price, historical sales quantity, and timestamps. The server loads these tables into main memory as tabular data structures and stores them in a data frame representation. The server uses numerical processing and statistical processing to generate distribution trend information, such as moving averages of sales, category-wise rankings, and trend scores, by performing operations over columns and rows of the tabular data.

The server implements a generative AI model as a neural network architecture, which may be a transformer-based model or a hybrid architecture that combines an embedding layer for categorical features, a recurrent or attention-based sequence processing layer for prompt sentences, and a dense output layer that produces relevance scores and textual proposal content. The server stores trained model parameters, including weight matrices and bias vectors, in non-volatile storage and loads them into main memory at runtime. The server performs inference by executing matrix multiplication, vector addition, non-linear activation functions, and attention score computations using a numerical computation framework running on the processor or an attached accelerator.

The server encodes user attribute information and user preference information into numerical feature information. The server represents categorical attributes such as style, color, and category with embedding vectors, each embedding vector being obtained by indexing into an embedding matrix based on an attribute identifier. The server represents numerical attributes such as budget, body measurements, and sales quantities as normalized floating-point values. The server concatenates these numerical features into fixed-length vectors that are provided as input to the generative AI model along with tokenized prompt sentences.

The terminal executes a client application that renders a user interface for inputting user attributes and preferences. The terminal displays form elements such as drop-down menus for style and color, sliders for budget, and text input fields for free-form requests. The user selects or enters values through the user interface. The terminal validates local input formats, constructs structured data reflecting the user's selections, and transmits the structured data to the server via the communication interface.

The server receives input information from the terminal and converts the input information into structured information that aligns with internal data schemas. The server then generates a prompt sentence for a generative AI model. The server constructs the prompt sentence based on the user attribute information, the user preference information, and the current distribution trend information. For example, the server generates a prompt sentence such as: “Suggest 5 casual-style fashion items in blue for a slim user, based on current bestseller information, and return item names, short descriptions, and image identifiers.”

In another example, the server generates a prompt sentence such as: “Given that the user prefers a casual style, black color, and has a slim body type with a budget of 150, propose a complete outfit using bestseller items only, including a jacket, a top, a bottom, and shoes.”

In a further example for refinement, the server generates a prompt sentence such as: “Refine the previous recommendations by changing the jacket color to black while keeping the rest of the outfit casual and suitable for a slim user, using current bestseller data and outputting updated item names and image identifiers.”

The server tokenizes the prompt sentence by converting the text into a sequence of token identifiers using a tokenizer associated with the generative AI model. The server then embeds the tokens through an embedding layer, combines the embedded prompt representation with the numerical feature information derived from user inputs and distribution trend information, and forwards the combined representation into subsequent layers of the neural network. The server thereby uses both natural language context and structured numerical features in a unified way.

The server applies an attention mechanism over the embedded tokens and features to compute context-aware vectors. The server calculates attention weights based on dot products between query, key, and value vectors, and uses these attention weights to weight and sum value vectors. This process allows the generative AI model to focus on particular portions of the prompt sentence and feature vectors that are relevant to the recommendation task. The server then applies one or more dense layers with non-linear activation functions such as rectified linear units to produce output vectors representing relevance scores for candidate merchandise and, optionally, token distributions for textual proposal content.

The server maintains a candidate set of merchandise items by referencing the distribution trend information stored in memory. The server computes relevance scores for each candidate by combining neural network output values with precomputed trend scores and constraints such as availability or price range. The server ranks the candidates based on a scoring function that may be a weighted sum or a non-linear combination of neural network outputs and trend scores. The server generates proposal candidate information by selecting top-ranked items and, when needed, grouping them into coherent outfits based on category compatibility rules.

The server stores image information in an image storage device such as a file server or an object storage service. The server associates each merchandise identifier with one or more image identifiers or paths. When the server selects proposal candidates, the server retrieves corresponding image information from the image storage device. The server constructs display information that includes item identifiers, textual descriptions, prices, relevance scores, and references to images. The server sends the display information to the terminal.

The terminal receives the display information and renders a user display screen. The terminal displays item cards showing names, descriptions, prices, and images of recommended merchandise. The user views the recommended items and uses input widgets on the terminal to express change requests, such as changing color, narrowing price range, or favoring certain categories. The terminal transmits change request information to the server in response to the user's operations.

The server also acquires state information relating to an emotional state of the user from the terminal. The terminal may infer emotional state based on explicit user input (for example, rating buttons or satisfaction sliders) or implicit behavior (for example, duration of item viewing, frequency of scrolling, or repeated rejection of similar items). The server receives this emotional state information and maps it to internal parameters, such as weights for diversity versus fidelity to previous choices, or adjustments to risk levels for suggesting items outside the user's habitual preferences.

The server updates the structured information based on the change request information and emotional state information. The server regenerates a prompt sentence that explicitly reflects the new constraints and emotional context. The server also updates numerical feature information by adjusting weights, feature values, or masks representing the user's updated intentions. The server inputs the new prompt sentence and numerical feature information into the same generative AI model and causes the model to perform re-inference processing. In this way, the server implements a low-latency feedback loop where each user refinement and emotional reaction is encoded into both natural language prompts and numerical features and used as fresh input for subsequent inference.

The server trains the generative AI model in advance using historical data that includes extended records of user interactions, merchandise attributes, and outcomes such as final purchases or user satisfaction scores. The server defines a loss function that may combine a ranking loss (for example, pairwise ranking loss or listwise loss) and a reconstruction loss for textual proposal content. The server performs weight updates using gradient-based optimization, such as stochastic gradient descent or adaptive methods, by computing gradients of the loss with respect to model parameters and adjusting the parameters in the direction that reduces the loss. The server may apply data augmentation such as rephrasing prompt sentences, perturbing preference vectors, or simulating synthetic emotion signals in order to improve model robustness.

The server stores the trained model parameters and uses them during runtime inference. Because the server maintains distribution trend information as in-memory tabular data and performs incremental updates rather than full recomputation for every request, the server reduces repeated access to the storage information source and decreases latencies associated with disk access. The server also reduces communication load between the server and the terminal by sending compact display information and by using structured change request messages instead of resending full context data.

The server improves computer technology by unifying natural language prompt generation and numerical feature generation within a single inference pipeline. Instead of relying only on either rule-based selection or purely textual queries, the server simultaneously feeds encoded trend data, user attributes, and emotional context into the generative AI model. This configuration enables the processor to exploit matrix operations and attention mechanisms more efficiently, thereby improving throughput for a large number of concurrent recommendation queries. Because the server aggregates and ranks candidate items based on model outputs and precomputed trend scores in memory, the server reduces the number of database queries and intermediate serialization operations, increasing processing speed.

The terminal benefits technically from this architecture because the terminal receives display information that is already structured and ranked, minimizing client-side processing. The terminal only needs to render updated display screens based on server outputs, allowing the terminal to maintain responsive interfaces even on constrained hardware. The user experiences faster updates due to the server's optimized inference and data handling, and the server's fine-grained control of prompts and features allows more accurate recommendations, reducing error rates in relevance estimation.

The server differs from manual human recommendation processing because the server applies non-intuitive combinations of attention-based scoring, distribution trend integration, and emotional state modulation. The server uses a set of numerical rules and learned parameters that are not easily replicated by a simple human-centric workflow. For example, the server adjusts the weight of exploration versus exploitation in ranking based on measured user frustration levels. The server can increase diversity when repeated rejections occur, or increase focus on similar items when positive emotional states are detected. These adjustments are implemented numerically in the scoring function and internal hidden representations, not as explicit business rules, and are realized through the generative AI model's architecture and training.

In another embodiment, the server uses different neural network architectures, such as a multi-layer perceptron combined with a convolutional sub-network for image-aware features or a recurrent network for sequential purchase histories. In such variants, the server still generates prompt sentences and numerical feature information, but configures the input interface of the generative AI model accordingly. For example, the server concatenates a representation of image features extracted from merchandise images with the feature vectors representing user preferences, and feeds the combined vector with the prompt sentence embedding into the network. This variant allows the server to further refine relevance scoring based on visual similarity or styling coherence.

In a further embodiment, the server deploys a distributed model serving architecture in which different instances of the generative AI model run on multiple processing nodes. The server partitions incoming requests based on user segments or merchandise categories and routes them to appropriate model instances. The server synchronizes distribution trend information between instances through a shared memory or message queue system. This arrangement improves scalability and fault tolerance while maintaining the unified prompt and feature-based inference framework.

The system as a whole thereby provides a concrete technical implementation involving specific data structures, model architectures, and processing flows that reduce redundant computation, improve memory locality, increase throughput of inference operations, and lower communication overhead between the server and terminal. The server, terminal, and user cooperate through clearly defined data exchanges and feedback signals. The system uses a generative AI model and prompt sentences in a way that is specifically tailored to the underlying hardware and software components, and produces a measurable improvement in processing speed, recommendation accuracy, and resource utilization compared to conventional recommendation systems that do not integrate distribution trend information, user attributes, user emotional states, and unified prompts with numerical features.

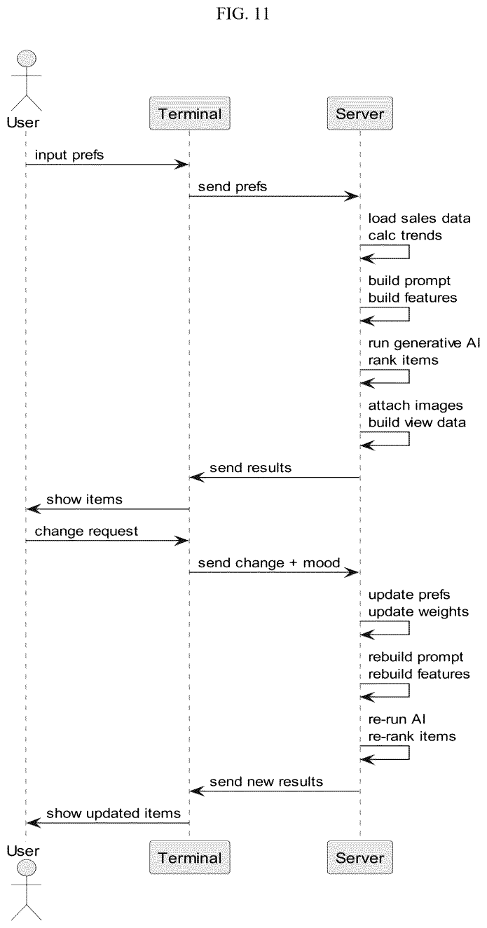

The following describes the processing flow using FIG. 11.

### Step 1

The server loads merchandise information including sales records from a storage information source into main memory.

The server receives, as input, raw records containing item identifiers, categories, prices, timestamps, and sales quantities.

The server performs data parsing, type conversion, and normalization on each field, and organizes the records into tabular data structures in memory.

The server outputs cleaned tabular data in which each row corresponds to one merchandise item and each column corresponds to an attribute or a computed metric.

### Step 2

The server generates distribution trend information based on the cleaned tabular data.

The server receives, as input, the in-memory tabular data created in Step 1.

The server performs numerical processing such as summing sales quantities per time window, computing moving averages, and calculating trend scores by combining recent sales and long-term sales with predetermined weights.

The server outputs distribution trend information in the form of additional columns appended to the tabular data, including trend scores and category-wise rankings for each merchandise item.

### Step 3

The terminal initializes and renders a user interface for collecting user attribute information and user preference information.

The terminal receives, as input, display configuration data and default option lists provided by the server or stored locally.

The terminal performs layout computation and draws interactive elements such as dropdown lists, sliders, and text input fields on the display device.

The terminal outputs a visible user display screen that allows the user to specify style, color, body type, budget, and free-text requirements.

### Step 4

The user operates the terminal to enter desired preferences and attributes.

The user provides, as input, selections from style and color dropdowns, numerical values for budget, and text such as “I want casual clothes for a weekend outing.”

The terminal captures these operations, updates its internal state for each UI control, and displays the currently selected values back to the user.

The terminal outputs structured input information representing the user's current selections and free-text entry.

### Step 5

The terminal transmits the structured input information to the server.

The terminal receives, as input, the internal representation of user attributes and preferences generated in Step 4.

The terminal serializes this information into a standardized message format and sends it over a communication path to the server using a network protocol.

The terminal outputs a request message that encapsulates user attribute information, user preference information, and a timestamp.

### Step 6

The server receives and validates the input information from the terminal.

The server receives, as input, the request message containing user attributes and preferences from Step 5.

The server parses the message, checks that required fields such as style, color, and body type are present, and verifies that numeric values such as budget are within allowed ranges.

The server outputs validated structured information, or, if validation fails, an error response sent back to the terminal.

### Step 7

The server constructs a prompt sentence for a generative AI model based on the validated structured information and the distribution trend information.

The server receives, as input, the validated user attribute and preference information from Step 6 and the distribution trend information from Step 2.

The server selects representative trend descriptors (for example, “top-selling casual jackets in the last month”) and inserts user-specific conditions into a natural language template to generate a prompt sentence such as “Suggest 5 casual-style fashion items in blue for a slim user, based on current bestseller information, and return item names, short descriptions, and image identifiers.”

The server outputs a finalized prompt sentence in text form that encodes both user requirements and trend context in natural language.

### Step 8

The server generates numerical feature information corresponding to the user and merchandise context.

The server receives, as input, the structured user information and distribution trend information from Steps 2 and 6.

The server transforms categorical attributes such as style and color into numerical vectors using embedding lookups or one-hot encodings, normalizes continuous attributes such as budget and trend scores, and concatenates these values into fixed-length feature vectors.

The server outputs numerical feature information that numerically encodes user attributes, preferences, and current distribution trends.

### Step 9

The server prepares model inputs by combining the prompt sentence with the numerical feature information.

The server receives, as input, the prompt sentence from Step 7 and the numerical feature information from Step 8.

The server tokenizes the prompt sentence into a sequence of token identifiers, maps the token identifiers to token embeddings, and aligns the embedded prompt representation with the feature vectors through concatenation or positional fusion.

The server outputs a set of tensors representing token embeddings and feature vectors, formatted as input data structures for the generative AI model.

### Step 10

The server executes inference using the generative AI model to compute relevance information and proposal content information.

The server receives, as input, the tensors generated in Step 9 and the stored model parameters of the generative AI model.

The server applies neural network operations including matrix multiplication, attention calculations, and non-linear activation across multiple layers to propagate the input through the model, thereby computing output values representing relevance scores for candidate merchandise items and, optionally, generated text for item descriptions.

The server outputs relevance information, such as per-item scores, and proposal content information, such as text fragments describing recommended items.

### Step 11

The server selects and ranks proposal candidates based on the model outputs and distribution trend information.

The server receives, as input, the relevance information and proposal content information from Step 10 and the distribution trend information from Step 2.

The server computes a final score for each merchandise item by combining model relevance scores with trend scores, availability flags, and constraints derived from user preferences, and performs a sorting operation to rank items from highest to lowest score.

The server outputs proposal candidate information that includes the identifiers of top-ranked items, their final scores, and any associated generated descriptions.

### Step 12

The server associates image information with each selected proposal candidate.

The server receives, as input, the proposal candidate information from Step 11.

The server queries an image storage device using merchandise identifiers to retrieve corresponding image references, such as file paths or identifiers, and merges these references into the candidate records.

The server outputs enriched proposal candidate information that includes item identifiers, descriptions, scores, and image information.

### Step 13

The server generates display information for the terminal.

The server receives, as input, the enriched proposal candidate information from Step 12.

The server formats the information into a structure suitable for presentation, including grouping items into visual sections, attaching textual labels, and arranging fields in display order, and packages the formatted data into a response message.

The server outputs display information that is ready to be rendered by the terminal user interface.

### Step 14

The terminal renders the received display information to the user.

The terminal receives, as input, the display information from Step 13 over the network.

The terminal parses the message, generates visual components such as item cards with images, names, prices, and descriptions, and draws them on the display device according to a layout policy.

The terminal outputs a fully rendered recommendation screen that presents proposal candidate information to the user for inspection.

### Step 15

The user reviews the displayed recommendation results and issues change requests if necessary.

The user receives, as input, the visual display of recommended items from Step 14.

The user evaluates the items and interacts with the interface, for example by selecting filters or entering text such as “Change the jacket color to black while keeping a casual style.” The user outputs change request information through the terminal, which encodes the modified preferences or constraints.

### Step 16

The terminal transmits change request information and updated emotional state information to the server.

The terminal receives, as input, the user's new selections, text entries, and implicit interaction signals such as item dismissals or satisfaction ratings from Step 15.

The terminal compiles these signals into structured change request information and, if available, derives or includes emotional state indicators such as satisfaction level or frustration level, and then sends a new request message to the server.

The terminal outputs a combined update message containing change request information and state information relating to the emotional state of the user.

### Step 17

The server updates structured information and regenerates model inputs based on the change request and emotional state.

The server receives, as input, the update message from Step 16 and the previously stored user and trend context from earlier steps.

The server modifies the stored user preference values, adjusts weighting parameters according to the emotional state (for example, increasing diversity when dissatisfaction is detected), and reconstructs a new prompt sentence that reflects the updated constraints and emotional context, along with updated numerical feature information.

The server outputs revised structured information, a new prompt sentence, and updated numerical feature information for re-inference.

### Step 18

The server performs re-inference with the generative AI model to obtain refined proposal candidate information.

The server receives, as input, the new prompt sentence and updated numerical feature information from Step 17.

The server repeats tokenization, embedding, and neural network inference operations as in Steps 9 and 10, generating new relevance information and proposal content information that reflect the updated preferences and emotional state.

The server outputs refined proposal candidate information after recomputing scores, re-ranking items, and enforcing the updated constraints.

### Step 19

The server regenerates display information for the refined recommendations and transmits it to the terminal.

The server receives, as input, the refined proposal candidate information from Step 18 and associated image information from the image storage device.

The server assembles updated display information, indicating which items are new or changed compared to previous results, and sends this information to the terminal.

The server outputs a refined display message so that the terminal can visually update the recommendation screen.

### Step 20

The terminal updates the visual display in near real time based on the refined display information.

The terminal receives, as input, the refined display message from Step 19.

The terminal compares the refined candidates with the previously shown items, updates the item list on the screen by adding, removing, or replacing visual components, and redraws the display with minimal latency to maintain a responsive user experience.

The terminal outputs an updated recommendation view that reflects the latest inference results and allows the user to continue the interaction cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recommendation systems for apparel items typically rely on static rules or simple statistical correlations between user attributes and item attributes. Such systems often operate as isolated components, where retrieval of sales trend information, personalization of recommendations, generation of explanatory text, and augmented reality (AR) based virtual try-on are handled separately or only loosely coupled. As a result, substantial computational resources are wasted on transferring and transforming data between subsystems, and the overall responsiveness and scalability of the system are degraded. Furthermore, existing systems do not effectively utilize user feedback obtained during virtual try-on sessions to adapt recommendation logic and improve subsequent recommendation accuracy at the system level.

Generative AI models have recently been used to generate natural language recommendations. However, in many implementations, the generative AI model is invoked with ad hoc prompts that do not systematically integrate structured sales trend information, user profile information, and feedback information obtained after AR-based virtual try-on. Because the construction and update of such prompts are not managed as part of a unified computational process, the system is unable to optimize the use of the generative AI model, leading to inefficiencies such as redundant model calls, inconsistent recommendation criteria, and suboptimal use of computing and storage resources.

Moreover, when AR-based virtual try-on is provided, conventional systems often treat AR rendering as a purely client-side visualization task, independent from the server-side recommendation engine. In such architectures, the server does not generate AR control data tailored to user-specific body information or to recommendation context, and therefore the mapping between recommended apparel items and AR visualization parameters remains coarse or manual. This separation results in increased latency, inconsistent user experiences across devices, and difficulty in systematically improving the quality of virtual try-on based on aggregated user evaluations.

Accordingly, there is a need for a computer-implemented system that tightly integrates (i) acquisition and weighting of sales trend information, (ii) construction and dynamic update of prompt sentences to be supplied to a generative AI model, (iii) generation and distribution of AR control data for virtual try-on, and (iv) collection and utilization of evaluation information from users. Such a system should improve the efficiency and technical performance of the recommendation pipeline, including reduction of redundant data processing, improvement of model utilization efficiency, enhancement of latency characteristics, and more effective use of limited computing resources in both server and terminal environments.

The specific processing by the specific processing unit 290 of the data processing device 12 in Application Example 1 is realized by the following means.

The present invention provides a server comprising a processor configured to (i) acquire user profile information including preference information and body information from a user terminal, and acquire sales trend information from a sales performance information storage device; (ii) generate a first prompt sentence that instructs extraction of candidates of apparel-related information to be presented to a user based on the user profile information and the sales trend information; (iii) generate a second prompt sentence that instructs a generative AI model, given the first prompt sentence including the user profile information and the sales trend information, to generate recommendation information including selection reasons for the candidates of the apparel-related information and combination proposals; (iv) generate display data by associating the recommendation information output from the generative AI model with image information corresponding to the apparel-related information, and transmit the display data to the user terminal; (v) specify three-dimensional display data or superimposition display image data corresponding to target apparel-related information based on an augmented reality display request and identification information of the target apparel-related information acquired from the user terminal, and transmit augmented reality data including control information used for virtual try-on display by the user terminal; and (vi) store evaluation information regarding the virtual try-on acquired from the user terminal, update generation contents of at least one of the first and second prompt sentences or weighting of the sales trend information based on the evaluation information, and generate an updated prompt sentence to improve generation accuracy of the recommendation information using the generative AI model. This enables a unified and technically efficient recommendation architecture in which sales trend acquisition, prompt construction for the generative AI model, generation of personalized recommendations, and delivery of optimized augmented reality control data are centrally coordinated by the server, thereby reducing redundant data processing, improving utilization of computational resources, lowering response latency, and adaptively enhancing recommendation accuracy and virtual try-on quality through feedback-driven updates at the system level.

The term “user profile information” refers to information indicating characteristics of a user, including at least preference information regarding styles, colors, or categories of apparel, and body information such as body size, body shape, or body measurements, which is acquired from a user terminal.

The term “preference information” refers to information representing a user's likes or dislikes with respect to attributes of items, including but not limited to style categories, color preferences, fit preferences, or usage scenes.

The term “body information” refers to information indicating physical attributes of a user, including at least one of height, weight, body measurements, body shape classification, or size preferences.

The term “user terminal” refers to an information processing apparatus operated by a user, including but not limited to a portable communication device, a wearable display device, or a general-purpose computing device, that is configured to communicate with a server, display information, and capture input from the user.

The term “sales trend information” refers to information derived from sales performance data of items, including at least one of sales volume, sales ranking, time-series sales transitions, or popularity indices, and indicating relative popularity or trend status of the items.

The term “sales performance information storage device” refers to a storage apparatus or storage system that stores sales performance data of items, such as transaction history data, item identifiers, and associated sales metrics, and that is accessible by a server.

The term “apparel-related information” refers to information associated with garments or fashion items, including at least item identifiers, item categories, size information, color information, style tags, descriptive text, and links to image or three-dimensional data.

The term “prompt sentence” refers to a sequence of characters, including natural language expressions and optionally structured metadata, that is provided as input to a generative AI model and that specifies conditions, constraints, or instructions for generation of output data by the generative AI model.

The term “generative AI model” refers to a trained machine learning model that generates output data, such as natural language text or structured information, in response to an input prompt sentence, based on learned statistical relationships in training data.

The term “recommendation information” refers to information generated based on user profile information and sales trend information, and includes at least one recommended apparel-related item, a selection reason for the recommended item, and optionally a coordination proposal indicating how multiple items may be combined.

The term “selection reason” refers to explanatory information indicating why a particular apparel-related item is recommended, including relationships between the item attributes and the user's preference information, body information, or sales trend information.

The term “combination proposal” refers to information indicating a suggested combination of plural apparel-related items or accessories, such as an outfit or coordinated set, and may include textual explanation or structured data specifying which items are to be combined.

The term “image information” refers to digital data representing a two-dimensional visual depiction of an item, including at least one of still image data, texture map data, or thumbnail data suitable for display on a user terminal.

The term “display data” refers to data generated by a server for transmission to a user terminal, including at least recommendation information and associated image information, and formatted for presentation by a user interface of the user terminal.

The term “augmented reality display request” refers to a request transmitted from a user terminal to a server, indicating that augmented reality-based visualization of a specific apparel-related item is to be initiated, and including at least identification information of the target item.

The term “identification information of the target apparel-related information” refers to information enabling unique identification of apparel-related information to be processed, including at least one of an item identifier, a product code, or a reference key.

The term “three-dimensional display data” refers to digital data representing a three-dimensional model of an item, including at least geometry data, material data, and rendering parameters suitable for visualization by an augmented reality or three-dimensional graphics engine.

The term “superimposition display image data” refers to digital data representing a two-dimensional or multi-layer image to be overlayed on a captured image in an augmented reality environment, and may include transparency information or alignment metadata.

The term “augmented reality data” refers to data transmitted from a server to a user terminal for use in an augmented reality environment, including at least one of three-dimensional display data, superimposition display image data, and control information for rendering or alignment.

The term “virtual try-on display” refers to an augmented reality-based visualization process in which an apparel-related item is visually overlaid on a representation of a user or a user's environment, such that the user can perceive an appearance similar to wearing the item.

The term “evaluation information” refers to information indicating a user's reaction to or assessment of a virtual try-on display or a recommended item, including at least one of explicit ratings, categorical feedback, or free-text comments transmitted from a user terminal.

The term “popularity index” refers to a numerical or categorical indicator associated with an apparel-related item, derived from sales trend information and optionally evaluation information, and representing a relative popularity or trend level of the item.

The term “control information” refers to data used by an augmented reality application executed on a user terminal to control rendering of three-dimensional display data or superimposition display image data, including at least one of alignment parameters, scaling parameters, orientation parameters, or timing parameters.

The term “augmented reality application” refers to a software program executed by a user terminal, which obtains captured images from an imaging device, performs environment or body tracking, and renders virtual objects or images in registration with the captured images.

The term “captured image” refers to image data obtained by an imaging device of a user terminal, such as a camera, representing a real-world scene including at least a user or a background environment.

The term “generation contents of the prompt sentence” refers to structural or semantic elements included in a prompt sentence, such as included attributes, constraints, formatting instructions, or weighting of conditions, which influence the behavior of the generative AI model.

The term “weighting of the sales trend information” refers to numerical or logical parameters that determine a degree of influence of sales trend information on recommendation information generation, including weights applied to popularity indices, sales metrics, or related attributes in constructing or updating prompt sentences.

In one embodiment, a server executes a recommendation system for virtual try-on of apparel-related items using a generative AI model and augmented reality rendering on a user terminal. The server includes at least one processor, a memory, a network interface, and access to a storage system functioning as a sales performance information storage device. The user terminal includes at least one processor, a memory, an imaging device, a display device, an input interface, and a network interface.

The server runs an application implemented in a general-purpose programming language, such as a scripting language runtime, in combination with a web framework providing request handling, routing, and serialization. The server accesses a relational database management system, such as a structured query database, to store and retrieve sales performance data and apparel-related information. The server also accesses a document-oriented or key-value database to store user profile information and evaluation information. The server further communicates with a generative AI model hosted either as a remote inference service or as a local neural network executing in a model inference engine, such as a neural network runtime library.

The terminal executes a native application implemented in a compiled programming language appropriate for a mobile operating system. The terminal initializes a graphical user interface framework for presenting forms, buttons, and lists, and an augmented reality software development kit such as a general AR framework for the corresponding platform. The terminal uses a camera module to acquire captured images of the real-world scene, and uses graphics APIs such as a low-level graphics library to render three-dimensional display data and superimposition display image data.

The server stores apparel-related information in a database as structured records, each record including an item identifier, a category, one or more style tags, one or more colors, available sizes, and references to image information and three-dimensional display data. The server associates each record with sales performance information including a sales count, a sales ranking, time-series sales statistics, and a popularity index. The sales performance information storage device may be implemented as a distributed storage cluster that the server accesses via structured queries.

The server stores user profile information as structured documents including preference information fields (for example, preferred style categories, preferred colors, preferred fit types) and body information fields (for example, height, weight, chest circumference, waist circumference, hip circumference, and body shape classification). The server updates the user profile information when the user modifies preferences or body measurements via the terminal.

The server constructs a prompt sentence as a sequence of characters combining natural language segments and embedded attribute values. The server formats the prompt sentence according to a predetermined template so that the generative AI model can parse and utilize the included information. For example, the server may generate a prompt sentence such as: “User preferences: casual style, prefers blue color, relaxed fit. User height: 165 cm, average body type. Trending items (with attributes): [Item A: blue denim jacket, slim fit, very popular among users in their 20s; Item B: blue oversized hoodie, relaxed fit, high sales this month; Item C: blue regular-fit chino pants, moderate popularity]. Based on the user preferences and body information, select the best 3 fashion items, explain why they match the user, and suggest how to coordinate them. Output a list of recommendations with fields: item_id, reason, and coordination_advice.”

The server uses this prompt sentence as input to the generative AI model. In one embodiment, the generative AI model is a transformer-based neural network comprising multiple self-attention layers, feedforward layers, and layer-normalization modules. The generative AI model is pre-trained on large-scale text data and optionally fine-tuned on fashion-related corpora and synthetic prompts. The server uses an inference engine implementing optimized matrix multiplication and attention mechanisms, such as attention weight caching and mixed-precision arithmetic, in order to reduce computational latency and memory consumption compared to naïve inference.

The server represents input tokens of the prompt sentence as integer indices, and the generative AI model converts these indices into embedding vectors through an embedding layer. The generative AI model propagates the embeddings through stacked attention blocks, where each block computes attention scores between tokens using scaled dot-product attention, applies a softmax operation, and aggregates weighted token representations. The server configures hyperparameters such as model depth, hidden dimension size, and number of attention heads. The server uses these architectural decisions to achieve an improved trade-off between recommendation quality and inference speed on the server hardware.

The server uses a loss function such as cross-entropy during prior training of the generative AI model and applies an optimization algorithm such as stochastic gradient descent with momentum or adaptive gradient methods to update network weights. The server or an associated training environment performs data augmentation by synthesizing additional training pairs of prompt sentences and recommendation outputs, for example by paraphrasing preference descriptions or perturbing sales trend values. As a result, the generative AI model learns robust mapping patterns between structured apparel-related information, user profiles, and explanation text, which cannot be easily replicated by manual rule-based systems.

The server computes feature representations of apparel-related information by converting style tags, categories, colors, and size ranges into token strings that are embedded into the same latent space as the user profile text. The server thereby enables the generative AI model to compute similarity and compatibility relationships based on joint embeddings. This representation is distinct from conventional collaborative filtering or simple statistical correlation, and allows the server to utilize rich semantic context from both user descriptions and item metadata.

The server uses a dedicated module to post-process the textual output of the generative AI model. The server parses the output to extract structured recommendation information, including item identifiers, selection reasons, and combination proposals. The server maps the item identifiers back to the database records and validates that the items are available and compatible with the user's size constraints. The server then generates display data consisting of textual recommendation information and references to image information, and transmits the display data to the terminal.

The terminal receives the display data and uses a JSON parser or equivalent structured data parser to extract item identifiers, text fields, and image references. The terminal uses an image loading library to asynchronously download the image information from a content storage service, and renders the images and text in a list or grid view. The terminal thereby allows the user to visually examine recommended items with minimal latency, as the server has already filtered and structured the data to match the terminal's display capabilities.

The server additionally generates augmented reality data by associating recommended items with either three-dimensional display data or superimposition display image data. The server stores three-dimensional display data in a format suitable for real-time rendering, such as a mesh representation with vertex attributes and material properties. The server may store per-size or per-fit variants of three-dimensional display data, and selects appropriate variants based on the user's body information. The server also computes control information for scaling, positioning, and orientation of the three-dimensional model relative to a canonical body coordinate frame, such that the terminal can apply fewer per-frame transformations.

The terminal uses the augmented reality framework to access the imaging device and perform environment tracking. The terminal tracks device pose and optionally body pose using built-in body-tracking APIs. The terminal loads the three-dimensional display data and the control information received from the server, and applies transformation matrices to align the virtual garment with the user's body in the captured image. The terminal renders the composed view at video frame rates using the device's graphics processing unit, taking advantage of the pre-computed alignment and scaling parameters from the server to reduce computational load on the terminal.

The server thus shifts part of the alignment computation from the terminal to the server side, allowing centralized optimization of three-dimensional display data and control information. Because the server has access to user profile information and global statistics about apparel sizes and body shapes, the server can compute more accurate initial alignment parameters than a generic client-side heuristic. This reduces trial-and-error adjustments on the terminal and improves both frame rate stability and alignment accuracy for virtual try-on.

The user provides evaluation information regarding the virtual try-on by interacting with UI elements on the terminal. The user may assign rating values, select qualitative feedback options such as “too tight” or “too loose,” or input free-text comments. The terminal sends the evaluation information to the server. The server stores the evaluation information in association with user identifiers and item identifiers.

The server applies natural language processing algorithms to parse free-text evaluation information. The server may use a tokenization and vectorization pipeline, such as word or subword embeddings, to convert text into feature vectors, and then classify sentiment or extract key phrases (for example, “sleeve too short” or “waist too wide”) using a classification model. The server updates popularity indices and other weighting parameters for items based on aggregated evaluation information and sales trend information. The server may decrease the popularity index of items receiving consistently negative feedback from similar body profiles, or increase the popularity index when evaluation information indicates high satisfaction.

The server further updates the generation contents of prompt sentences based on evaluation information. For example, the server may adjust prompt templates to explicitly encode newly learned preferences such as “user generally prefers looser fit in the shoulder area” or “user dislikes dark navy color.” The server maintains prompt templates as data structures containing slots for attributes and weighting indicators. The server modifies which attributes are emphasized in prompt sentences and in what order they are presented to the generative AI model. This targeted modification of prompt sentences constitutes an algorithmic adjustment that improves the effective utilization of the generative AI model without re-training the entire model.

The server thereby achieves a technical effect where recommendation accuracy improves over time due to feedback-driven adjustment of both sales trend weighting and prompt structure. Because prompt updates occur on the server with access to aggregated evaluation information and global statistics, the system avoids redundant computations on individual terminals and reduces network traffic by transmitting only optimized display data and augmented reality data.

The server also improves computational efficiency through batching and caching. The server may batch multiple recommendation requests and feed them into the generative AI model in a combined form, utilizing matrix operations on modern hardware. The server may cache intermediate representations or attention key-value pairs for frequently used prompt parts, such as standardized descriptions of core style categories or typical body shapes, reducing recomputation across requests. These techniques reduce response time and server energy consumption.

The system thus is not limited to an abstract idea of recommending items, but instead provides concrete improvements in computer technology. The server defines specific data structures for user profile information, apparel-related information, three-dimensional display data, and evaluation information; generates structured prompt sentences that combine these data types; and uses a specialized neural network architecture and training approach. The system also generates low-level control information for augmented reality rendering and uses feedback to update algorithmic parameters and prompt structures. This results in measurable improvements such as shorter end-to-end latency for recommendation and virtual try-on flows, reduced network bandwidth usage due to pre-filtered and pre-structured data, and improved alignment accuracy and frame rate stability in AR rendering.

In another embodiment, the server hosts the generative AI model locally using a model inference engine that supports quantized weights or model distillation to further reduce memory footprint and improve throughput. The server may maintain several model variants specialized for different item categories or user segments, and select an appropriate model variant based on user profile information. The server thereby optimizes resource allocation by routing requests to the most suitable model architecture.

In another embodiment, the server uses a hybrid approach in which a deterministic ranking module computes an initial candidate set of apparel-related items using vector similarity search on pre-computed embeddings, and the generative AI model refines the ranking and produces human-readable selection reasons and combination proposals. The deterministic module uses an index structure such as an approximate nearest neighbor graph or tree to accelerate retrieval. This layered configuration further reduces the search space before neural inference and thereby improves system scalability when the catalog size grows.

In yet another embodiment, the terminal includes an auxiliary module that can perform local fallback recommendations if connectivity to the server is temporarily lost. The terminal may cache recent display data and augmented reality data and re-use them to provide limited functionality. However, the primary recommendation logic, prompt sentence generation, and feedback aggregation remain on the server to ensure centralized optimization and consistent updates across all terminals.

The system architecture, with clear separation of responsibilities between the server and the terminal, specific data structures, defined prompt sentence templates, and explicit use of a transformer-based generative AI model and AR control information, enables others skilled in the art to implement the invention. The described embodiments demonstrate how the integration of generative AI models, structured prompt sentences, and augmented reality rendering can improve processing speed, recommendation precision, resource utilization, and quality of virtual try-on experiences in a technically specific and non-abstract manner.

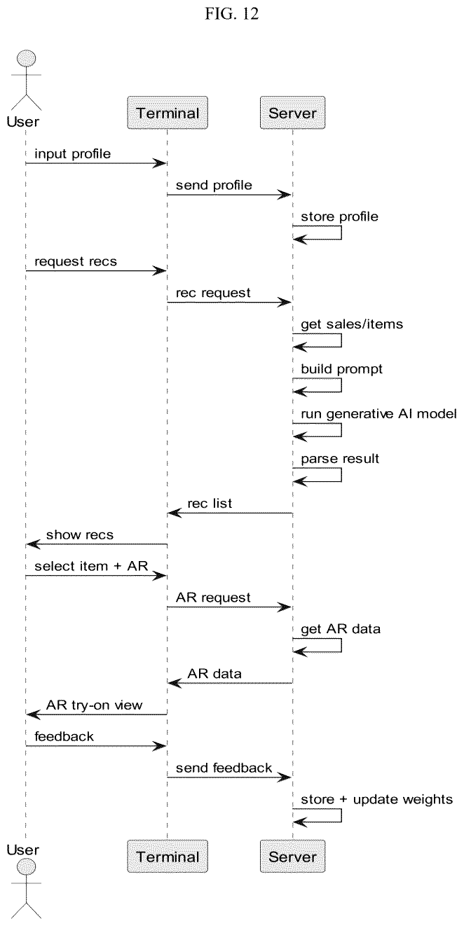

The following describes the processing flow using FIG. 12.

### Step 1

User operates the terminal to input preference information and body information. User touches UI components such as text fields, sliders, and selection buttons to specify style preferences (for example, casual, formal), color preferences, and body measurements (for example, height, weight, circumferences). The input of this step is raw user interactions on the terminal UI. The output of this step is structured user profile data displayed on the terminal screen and temporarily held in terminal memory.

### Step 2

Terminal converts the user profile data into a structured data object and transmits it to the server. Terminal serializes the preference information and body information into a structured format such as a key-value map, attaches a user identifier or session token, and sends the data to the server via a network request. The input of this step is the structured user profile data from Step 1. The output of this step is a network message containing the user profile information delivered to the server.

### Step 3

Server receives the network message and stores the user profile information in a storage system. Server parses the structured data, validates numeric ranges and required fields, and maps the received values into database columns or document fields. Server then writes or updates a user profile record in persistent storage. The input of this step is the user profile message from the terminal. The output of this step is an updated user profile record stored in the user database.

### Step 4

Server acquires sales trend information from the sales performance information storage device. Server executes a query against a sales performance table or collection to retrieve recent sales counts, rankings, and popularity indices for apparel-related items. Server may perform data aggregation, such as summing sales by item and calculating normalized popularity scores. The input of this step is a query condition set, for example a time window or item category filter. The output of this step is a list of apparel-related items with associated sales trend fields held in server memory.

### Step 5

Server filters and structures apparel-related information as candidate items. Server joins the sales trend information with static metadata of items (for example, category, colors, sizes, style tags) retrieved from an item master database. Server discards items that do not meet basic constraints, such as incompatible size ranges relative to the user's body information. The input of this step is the sales trend list from Step 4 and item metadata from the item database. The output of this step is a candidate item set containing item identifiers, attributes, and sales trend values.

### Step 6

Server generates a prompt sentence describing the user profile and the candidate item set. Server selects key preference attributes and compresses the candidate item set into textual descriptions, for example by concatenating item names, colors, fits, and popularity notes. Server embeds this information into a prompt template. For example, the server may construct a prompt sentence such as: “User preferences: casual style, prefers blue color, relaxed fit. User height: 165 cm, average body type. Trending items (with attributes): [Item A: blue denim jacket, slim fit, very popular among users in their 20s; Item B: blue oversized hoodie, relaxed fit, high sales this month; Item C: blue regular-fit chino pants, moderate popularity]. Based on the user preferences and body information, select the best 3 fashion items, explain why they match the user, and suggest how to coordinate them.” The input of this step is the user profile record from Step 3 and the candidate item set from Step 5. The output of this step is a text prompt sentence ready to be supplied to the generative AI model.

### Step 7

Server executes generative AI model inference using the prompt sentence. Server tokenizes the prompt sentence into token IDs, feeds them into a transformer-based neural network, and performs matrix multiplications and attention computations to generate output tokens. Server configures inference parameters such as temperature and maximum output length. The input of this step is the prompt sentence from Step 6. The output of this step is a generated text sequence containing recommendation information, including recommended item identifiers, selection reasons, and optional combination proposals.

### Step 8

Server parses the generated recommendation text into structured recommendation information. Server applies pattern matching or lightweight parsing rules to extract fields such as item identifiers, reason strings, and coordination advice. Server verifies that each item identifier corresponds to an item in the candidate item set, and removes any invalid or unavailable items. The input of this step is the raw generated text from Step 7. The output of this step is a structured recommendation list where each element includes an item identifier and associated explanation fields.

### Step 9

Server prepares display data that associates recommendation information with image information. Server queries an image storage index using item identifiers to retrieve URLs or references for images and, if available, thumbnail variants. Server combines textual recommendation fields with image references into a structured response object tailored for the terminal UI. The input of this step is the structured recommendation list from Step 8 and image index data from storage. The output of this step is display data containing recommendation entries with item identifiers, text descriptions, and image references.

### Step 10

Server transmits the display data to the terminal. Server serializes the display data into a network message and sends it via a response to the terminal's request. The input of this step is the display data from Step 9. The output of this step is a network response carrying the recommendation entries to the terminal.

### Step 11

Terminal receives and renders the recommendation list. Terminal parses the display data, extracts text and image references, and uses an image loading module to download corresponding image files or thumbnails from a content storage service. Terminal creates and populates UI components such as list cells or grid tiles with text labels and images. The input of this step is the server response from Step 10 and the image files obtained from the image service. The output of this step is a visually displayed recommendation list on the terminal screen.

### Step 12

User browses the recommendation list and selects a target item for virtual try-on. User scrolls through the displayed items, reads the descriptions, and taps an item to open a detail view. The input of this step is the rendered recommendation UI from Step 11. The output of this step is a user selection event identifying a target item.

### Step 13

Terminal sends an augmented reality display request for the selected item to the server. Terminal collects the target item identifier and, optionally, local device capabilities or current orientation data, constructs an AR request message, and transmits it to the server. The input of this step is the user selection event from Step 12. The output of this step is a network message containing the AR display request and the target item identifier.

### Step 14

Server identifies three-dimensional display data or superimposition display image data for the target item and generates augmented reality data. Server retrieves from storage the appropriate 3D mesh, texture, or overlay image associated with the target item, and computes or retrieves control parameters for alignment, scaling, and orientation corresponding to typical body dimensions or the user's body information. Server packs the visual asset reference and control information into an AR data structure. The input of this step is the AR display request with the target item identifier from Step 13 and the stored AR asset records. The output of this step is augmented reality data including asset references and rendering control parameters.

### Step 15

Server transmits the augmented reality data to the terminal. Server serializes the AR data and sends it as a response message via the network. The input of this step is the augmented reality data from Step 14. The output of this step is a network response carrying the AR asset reference and control information to the terminal.

### Step 16

Terminal initializes an augmented reality session and loads the received AR assets. Terminal activates the camera, starts environment or body tracking through an AR framework, and uses a graphics engine to load the 3D mesh or overlay image. Terminal applies the control parameters from the server to compute an initial transformation matrix for positioning the virtual garment relative to the captured image. The input of this step is the augmented reality data from Step 15 and the live camera feed. The output of this step is an initialized AR scene with the virtual garment object ready for rendering.

### Step 17

Terminal renders the virtual try-on view in real time. Terminal continuously acquires image frames from the camera, updates device and body pose estimates, transforms the virtual garment model according to updated pose and precomputed scaling factors, and composites the virtual garment onto each frame using the graphics processing unit. The input of this step is the initialized AR scene from Step 16 and the stream of camera frames. The output of this step is a real-time virtual try-on display presented on the terminal.

### Step 18

User evaluates the virtual try-on and inputs evaluation information. User observes the AR display, judges fit and appearance, and interacts with on-screen controls to provide ratings, categorical feedback, or text comments (for example, “too tight around shoulders” or “perfect length”). The input of this step is the virtual try-on display from Step 17. The output of this step is evaluation data entered by the user.

### Step 19

Terminal transmits the evaluation information to the server. Terminal packages rating values, categorical labels, text comments, and associated item and user identifiers into a structured message and sends it over the network. The input of this step is the evaluation data from Step 18. The output of this step is a feedback message delivered to the server.

### Step 20

Server stores the evaluation information and updates internal indices and prompt generation parameters. Server writes the received evaluation information into a feedback storage, associates it with corresponding user and item records, and updates popularity indices or satisfaction metrics using aggregation functions such as averages or weighted sums. Server also refines prompt templates by adjusting which attributes and weights are emphasized when constructing future prompt sentences, based on observed patterns in evaluation information. The input of this step is the feedback message from Step 19 and existing sales trend and evaluation records. The output of this step is updated popularity indices and modified prompt generation parameters stored in server memory and databases.

### Step 21

Server uses the updated indices and parameters in subsequent recommendation cycles. Server incorporates the new popularity indices and revised prompt templates when generating future prompt sentences, thereby changing the data processing flow in Steps 4 through 7. The input of this step is the updated popularity indices and prompt parameters from Step 20. The output of this step is a modified recommendation computation path that produces improved recommendation information for the user and for other users with similar profiles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems that propose fashion or other consumer items typically rely on fixed rule sets or simple statistical models operating directly on transaction records. Such architectures often retrieve bestseller lists and apply static filters based on user-selected attributes, such as category, color, or size. However, these systems exhibit several technical limitations from the standpoint of computer technology.

First, conventional systems do not provide an efficient mechanism for dynamically integrating large-scale, frequently updated sales trend data with unstructured, natural language user input in a unified computation flow. As a result, a processor must separately handle structured database queries and heuristic text parsing, which leads to redundant processing, increased memory access overhead, and suboptimal use of computational resources when generating recommendations.

Second, many existing systems treat a generative AI model, if used at all, as an isolated component that produces free-form text suggestions without tight coupling to a structured internal data representation such as a ranked bestseller dataset. Because the prompts supplied to the generative AI model are ad hoc and not systematically constructed from machine-readable ranking information and normalized user attributes, the model's output may refer to items that are unavailable, inconsistent with current sales trends, or misaligned with the user's constraints. This lack of structured prompt control yields unstable recommendation quality and complicates validation and post-processing on the server side.

Third, conventional designs typically do not log and analyze the exact prompt sentences and model outputs as first-class system artifacts for iterative improvement of the computational pipeline. Without systematic logging of prompt sentences, there is no machine-tractable record that relates low-level model inputs and outputs to user behavior data. This prevents effective offline optimization of prompt generation rules and model operating parameters, and thus hinders continuous improvement of the technical performance of the recommendation engine.

Fourth, feedback loops from the user terminal to the server are often limited to simple binary signals such as “like” or “dislike,” which are handled independently from the main data processing pipeline. Systems rarely use such feedback to automatically refine both the attribute representation of user preferences and the associated prompt sentences for the generative AI model in a session-based, iterative manner. Consequently, the server cannot efficiently exploit user interaction data to update in-memory representations and reduce the number of server-model-terminal communication cycles required to converge to relevant recommendations.

Fifth, from a user interface control perspective, conventional systems usually render recommendations as isolated items without machine-level grouping logic that connects the groups to the server's internal representation of ranked items and generative outputs. The lack of explicit coordination group information in the data returned from the server forces the terminal to perform ad hoc, presentation-only grouping, which is detached from the underlying computational process and does not contribute to improving system-level behavior such as caching, prefetching, or adaptive ranking.

Accordingly, there is a need for a computer-implemented system that (i) structurally integrates sales trend ranking information, normalized user attribute information, and prompt sentences for a generative AI model; (ii) programmatically controls the generation, logging, and analysis of such prompt sentences; (iii) iteratively refines recommendation candidate information based on user feedback; and (iv) provides coordinated control of the terminal device for visual presentation and interaction, thereby improving the efficiency, stability, and adaptability of the recommendation computation performed by the processor and associated components.

The specific processing by the specific processing unit 290 of the data processing device 12 in Example 2 is realized by the following means.

The present invention provides a server comprising a processor, a storage device, and an interface to a terminal device and an external aggregation storage, the processor being configured to execute instructions to acquire sales trend information from the external aggregation storage, calculate a sales index for each item based on the acquired sales trend information, and store, in the storage device, ranking information in which the items are ordered according to the sales index; to obtain, via the interface, the ranking information and preference information expressed in natural language from a user through the terminal device, convert the preference information into attribute information by language processing, generate a prompt sentence including the ranking information and the attribute information, and input the prompt sentence to a generative AI model so as to cause the generative AI model to generate recommendation candidate information; to compare item identification information included in the recommendation candidate information with the ranking information, generate recommendation information to which item information and explanation information are added based on a comparison result, and transmit the recommendation information to the terminal device; to obtain evaluation information and additional natural language input of the user from the terminal device, update the attribute information based on the evaluation information and the additional natural language input, generate a revised prompt sentence including the updated attribute information and the ranking information, and input the revised prompt sentence to the generative AI model so as to sequentially update the recommendation candidate information; to store at least the prompt sentence and the revised prompt sentence as log information in the storage device, analyze the log information to update at least one of generation rules of the prompt sentence and operation conditions of the generative AI model; and to control, via the interface, the terminal device to display the recommendation information in a plurality of item groups as respective coordination candidates on a visual proposal screen and to transmit, to the server, operation contents corresponding to selection operations and customization operations performed by the user on the coordination candidates. This enables structured integration of sales ranking data, normalized user attributes, and generative AI prompts in a single computational pipeline, thereby improving the efficiency, consistency, and adaptability of recommendation processing and enhancing the overall performance of the computer-implemented recommendation system.

The term “processor” refers to a hardware or virtual computation unit, such as a central processing unit or an execution core, that executes program instructions to perform data processing operations defined by software.

The term “storage device” refers to a physical or virtual data retention component, such as a memory device or a non-volatile storage medium, that stores program instructions, ranking information, log information, and other data used by the processor.

The term “terminal device” refers to an information processing apparatus, such as a user-operated computing device, that provides an interface for inputting user information and for displaying recommendation information received from the server.

The term “external aggregation storage” refers to a data management resource, such as an external database or data repository, that accumulates and provides sales-related information or trend information for multiple items.

The term “sales trend information” refers to data representing transactional or popularity characteristics of items over time, including at least sales volume information, frequency information, or recency information, which can be used to determine relative item popularity.

The term “sales index” refers to a numerical or ordered measure calculated from sales trend information, which quantifies a relative degree of sales performance or popularity of each item.

The term “ranking information” refers to structured data that arranges items in an order based on the sales index, and associates each item with one or more attributes indicating its relative position or score.

The term “preference information” refers to information indicating a user's desired characteristics or conditions for items, the information being expressed at least partially in natural language and optionally combined with structured selections.

The term “natural language” refers to a human language expression, such as a text sentence or phrase, that is not constrained to predefined codes or fixed command formats and that requires language processing to extract machine-usable meaning.

The term “attribute information” refers to structured data derived from preference information by language processing, the structured data describing normalized user preference parameters such as style, color, body type, budget range, or usage scene.

The term “language processing” refers to a sequence of computational operations that analyze a natural language expression, including at least tokenization, parsing, and semantic interpretation, to derive attribute information usable for subsequent processing.

The term “prompt sentence” refers to a text-based input sequence generated by the processor, which includes at least the ranking information and the attribute information, and which is formatted to be supplied to a generative AI model as a condition or instruction for generating output.

The term “revised prompt sentence” refers to a modified prompt sentence that includes updated attribute information and at least part of the ranking information, the modified prompt sentence being generated after acquisition of user evaluation information or additional natural language input.

The term “generative AI model” refers to a machine learning model, such as a neural network-based language model, that generates text or structured data outputs in response to an input prompt sentence by performing parameterized numerical computations.

The term “recommendation candidate information” refers to output data generated by the generative AI model in response to a prompt sentence, the output data including at least candidate item identification information and optionally explanation content or grouping information.

The term “item identification information” refers to data that uniquely or specifically identifies an item within a set of items, such as an item code, an item index, or attribute combinations sufficient to distinguish the item.

The term “recommendation information” refers to structured data generated by the processor based on recommendation candidate information and ranking information, the structured data including at least item information and explanation information for presentation to the user.

The term “item information” refers to structured data describing properties of an item, such as category, name, attribute values, availability information, and one or more references to associated media resources.

The term “explanation information” refers to text or symbol data that explains reasons or contexts for recommending an item, the explanation being derived at least in part from outputs of the generative AI model.

The term “evaluation information” refers to data indicating the user's evaluation, feedback, or reaction to presented items or recommendations, including at least explicit operations such as selection, rejection, or preference markings.

The term “log information” refers to recorded data that stores at least prompt sentences, revised prompt sentences, model outputs, and associated context information, for later analysis and system optimization.

The term “generation rules of the prompt sentence” refers to configuration data or algorithmic specifications that determine how ranking information, attribute information, and other contextual data are combined or formatted into a prompt sentence.

The term “operation conditions of the generative AI model” refers to configuration parameters controlling execution of the generative AI model, including at least inference hyperparameters, resource allocation settings, or model selection settings.

The term “visual proposal screen” refers to a display configuration on the terminal device that visually presents recommendation information, including item images, texts, and groupings, in a format that allows user interaction.

The term “coordination candidate” refers to a group of two or more items that are associated by the processor as a coordinated set suitable for joint use, and that are displayed together as a combination on the visual proposal screen.

The term “selection operation” refers to a user interaction on the terminal device that designates one or more items or coordination candidates as chosen, favored, or targeted for further processing.

The term “customization operation” refers to a user interaction on the terminal device that modifies one or more parameters associated with an item or a coordination candidate, such as size, color variation, quantity, or other selectable options.

In one embodiment, a server cooperates with a terminal and a user to implement a recommendation system that generates item proposals based on sales trend information and user preferences. The server includes at least one processor, a main memory, a non-volatile storage device, and a communication interface. The processor executes program instructions stored in the non-volatile storage and loaded into the main memory. The non-volatile storage can be implemented, for example, by a magnetic disk device, a solid-state storage device, or a network-attached storage system. The terminal is implemented by a user-operable information processing apparatus such as a smartphone, a tablet, a personal computer, or an embedded display device, and includes a display unit, an input unit, and a communication interface.

The server uses a relational database management system, such as a structured query language (SQL) database engine running on an operating system, as the storage device for ranking information and log information. The server uses a data processing runtime, such as a general-purpose scripting runtime with numerical libraries, to execute numerical operations for calculating sales indices and popularity scores. The server uses a language processing library, such as a natural language processing toolkit executing on the processor, to convert user preference information expressed in natural language into attribute information. The server further uses a generative AI model implemented as a neural network-based language model, such as a transformer architecture executed on a graphics processing unit or a tensor computation accelerator, to generate recommendation candidate information from a prompt sentence.

The server acquires sales trend information from an external aggregation storage that accumulates transaction records and item metadata from multiple sources. The external aggregation storage is implemented, for example, by a distributed database cluster or a data warehouse system. The server sends database queries through the communication interface using a database access protocol. The server receives tabular records comprising item identifiers, timestamps, quantities, categories, and other attributes. The server loads the records into main memory and performs aggregation operations for each item, including summation of quantities, calculation of time-decayed frequency measures, and normalization of values. The server calculates a sales index for each item by applying a weighted function of at least the total quantity sold, the recency of sales, and the variability of sales over a predetermined period.

The server stores ranking information in the storage device. The ranking information is represented as a table structure containing fields for an item identifier, a sales index value, a ranking position, and additional attribute fields such as category, style, and color. The server maintains index structures, such as B-tree indexes or hash indexes, over selected fields of the ranking information to accelerate retrieval operations. The server periodically updates the ranking information using batch processing tasks or scheduled processes. The server compares newly acquired sales trend information with stored data and recomputes the sales index only for affected items, thereby reducing computational load.

The terminal presents a graphical user interface that allows the user to input preference information in natural language and through structured controls. The terminal displays text entry fields and selectable options such as style, main color, budget range, or intended usage scene. The user inputs a natural language sentence, for example, “I want a casual style with blue items for a slim body type.” The terminal encodes this sentence as text data and combines it with any structured selections into a request message. The terminal transmits the request to the server using a network protocol, such as HTTP over a secure transport layer.

The server receives the request and extracts the natural language sentence and structured selections. The server applies language processing to the natural language sentence using a pipeline consisting of tokenization, part-of-speech tagging, syntactic parsing, and named-entity or attribute extraction. The server maps textual expressions to normalized attribute codes, such as mapping “casual” to a style code, “blue” to a color code, and “slim body type” to a body-type code. The server combines these codes with the structured selections and stores them in a data structure that represents attribute information for the current recommendation context.

The server generates a prompt sentence by integrating the ranking information and the attribute information. The server retrieves, from the ranking information, a set of items that satisfy basic constraints, such as style and color, and orders the items by sales index. The server selects a subset of top-ranked items and converts their attributes into a concise textual description. The server concatenates the user attribute information and the item descriptions to form the prompt sentence. For example, the server generates a prompt sentence such as: “User preferences: style=casual; main color=blue; body type=slim; occasion=weekend outing.

Bestseller data (top 10 items):
1. ID 101: blue denim jacket, slim fit, high popularity.
2. ID 205: navy hoodie, regular fit, mid-range price.
3. ID 330: blue sneakers, lightweight, casual style.

Task: As a fashion recommendation assistant, using the above bestseller data, recommend 5 specific items that best match the user's preferences. For each item, return the item ID and one sentence explaining why it fits the user's profile and current trends.”

The server structures the prompt sentence according to prompt generation rules that specify the order of sections, the level of detail, and the inclusion of particular attributes. The server ensures that the prompt sentence satisfies resource constraints such as maximum token length by truncating or summarizing less important items and by compressing textual descriptions. The server inputs the prompt sentence to the generative AI model. In one embodiment, the generative AI model is implemented as a multi-layer transformer network comprising an embedding layer, a plurality of self-attention layers, and a final output projection layer. The model receives the prompt sentence as a sequence of token identifiers, converts the tokens into vector embeddings, and processes the embeddings through the attention layers to generate contextual representations. The model generates output tokens that encode recommendation candidate information, including item identifiers and explanation sentences. The server configures operation conditions of the model, such as temperature, sampling strategy, and maximum number of output tokens, to balance variety and stability of recommendations.

The server receives the output text from the generative AI model and parses it to extract item identification information and explanation segments. The server uses parsing rules or pattern matching to recognize item identifiers and associated explanatory text. The server verifies that each extracted item identifier corresponds to an item present in the ranking information. When an identifier generated by the model does not correspond to an existing item, the server can discard that portion of the output or map it to a nearest candidate based on similarity of attributes. By enforcing this validation step, the server prevents the model from introducing invalid or non-existent items into the recommendation information.

The server constructs recommendation information by enriching the validated candidate list with item information from the storage device. The server retrieves attributes such as name, category, price, media references, and available variations. The server associates each item with the corresponding explanation information derived from the generative AI output. The server can classify items into coordination candidates by grouping items sharing compatible attributes, such as pairing outerwear, tops, and footwear into a single coordinated combination. The server encodes the recommendation information as structured data and transmits it to the terminal.

The terminal receives the recommendation information and generates a visual proposal screen. The terminal obtains the associated image data from a media storage or a content delivery infrastructure and arranges item images and texts on the display unit. The terminal visually separates different coordination candidates, for example, by displaying groups in distinct sections or panels. The user can scroll through the proposal screen, select items or groups, and perform customization operations such as changing size or color variations.

The user can also provide evaluation information or additional natural language input through the terminal. For example, the user can indicate a preference such as “Show me similar casual blue items but slightly warmer for early spring, and keep a slim fit.” The terminal transmits this additional input and evaluation information, such as liked or disliked items, to the server. The server updates the attribute information by adding or modifying attributes to reflect the new preference, for example, including a season attribute and a material attribute indicating warmer fabrics.

The server generates a revised prompt sentence that includes the updated attribute information and at least part of the ranking information. For instance, the server can generate a revised prompt sentence such as:

“User previously liked items 101 and 205 (casual blue jacket and hoodie) and disliked items 309 and 412 (too light for early spring).

User now says: ‘Show me similar casual blue items but slightly warmer for early spring, and keep a slim fit.’

Filtered bestseller data (warmer casual blue items suitable for early spring):
1. ID 150: lined denim jacket, slim fit, medium weight.
2. ID 260: fleece-lined hoodie, slim fit, warm fabric.

Task: Propose 5 new items that are warmer than the disliked items, maintain a casual blue style for a slim body type, and avoid lightweight fabrics. For each item, return the item ID and one-sentence reasons.”

The server inputs the revised prompt sentence into the generative AI model and obtains updated recommendation candidate information. The server then repeats the validation and enrichment process to produce updated recommendation information. The terminal receives the updated recommendation information and refreshes the visual proposal screen, indicating that the suggestions have been refined based on the user's feedback.

The server stores the prompt sentences, revised prompt sentences, and associated model outputs as log information in the storage device. The server periodically analyzes the log information using statistical methods and machine learning techniques. The server identifies correlations between prompt sentence structures, model parameters, and observed user behavior metrics such as selection rate or modification frequency. Based on this analysis, the server updates generation rules of the prompt sentence, such as adjusting the number of items included in the ranking portion or changing the order of attributes, and adjusts operation conditions of the generative AI model, such as modifying sampling parameters or selecting alternative model variants.

By systematically logging and analyzing prompt sentences and model outputs, the server improves the internal computational pipeline independently of specific business logic. The server reduces the average number of communication cycles needed to converge to useful recommendations, thereby decreasing network traffic and latency. The server also reduces processing load by narrowing model input data based on ranking information and user attributes, which decreases the size of the prompt sentence and the necessary number of inference operations in the generative AI model.

The server implements specific data structures and control logic to achieve these effects. The attribute information is stored as compact codes or vectors, allowing efficient computation when filtering ranking information. The ranking information is indexed for fast lookup, so that candidate sets can be generated quickly even from large item catalogs. The prompt sentence generation logic uses templates parametrized by attribute codes and ranking summaries, which can be instantiated efficiently and consistently. The validation step aligns the generative AI output with the structured ranking information, reducing error propagation and improving determinism in the system's behavior.

The server uses a trained generative AI model whose internal parameters have been obtained by supervised or self-supervised learning on large corpora of text and structured recommendation data. During training, the server or an associated training system computes an error function, such as a cross-entropy loss between predicted tokens and target tokens, and updates the weights of the neural network using gradient-based optimization. The training data can include historical prompt sentences, associated correct item selections, and explanation texts. The server can further refine the model using domain-specific data, such as fashion-related text and user interaction data, to improve alignment with the specific application.

The system thereby achieves technical effects that go beyond a mere automation of human selection work. The server integrates the ranking information, attribute information, and generative AI output into a single computational pipeline with explicit intermediate representations and control steps. This integration reduces redundant computations, constrains the generative process to valid item spaces, and allows continuous optimization of prompt design and model parameters based on logged data. These features lead to improved accuracy in recommendation results, shortened response times due to efficient filtering and indexing, reduced communication overhead due to fewer iterations and smaller message sizes, and enhanced data management through structured logging and analysis.

In alternative embodiments, the server can use different database structures, such as a key-value store or a columnar database, for storing ranking information and log information. The language processing component can be implemented by rule-based parsers, statistical models, or neural encoders. The generative AI model can have different architectures, including recurrent neural networks, convolution-based models, or hybrid systems that combine symbolic reasoning with neural generation. The terminal can be implemented as a web client, a native mobile client, or an embedded interface in a dedicated appliance. In all such embodiments, the server performs coordinated control of data structures, language processing, prompt sentence generation, generative inference, validation, and logging in a manner that improves the technical performance of the recommendation system as a whole. The user can employ the system in various domains where items must be recommended based on dynamic trend information and complex preference expressions. The user interacts only with the terminal interface, while the server performs the underlying technical operations that manage sales trend data, transform natural language into structured attributes, generate and refine prompt sentences for the generative AI model, and ensure that the recommendations are compatible with current item availability and precomputed ranking information. Through this configuration, the system provides a concrete, machine-implemented mechanism for generating high-quality recommendations with improved computational efficiency and robustness.

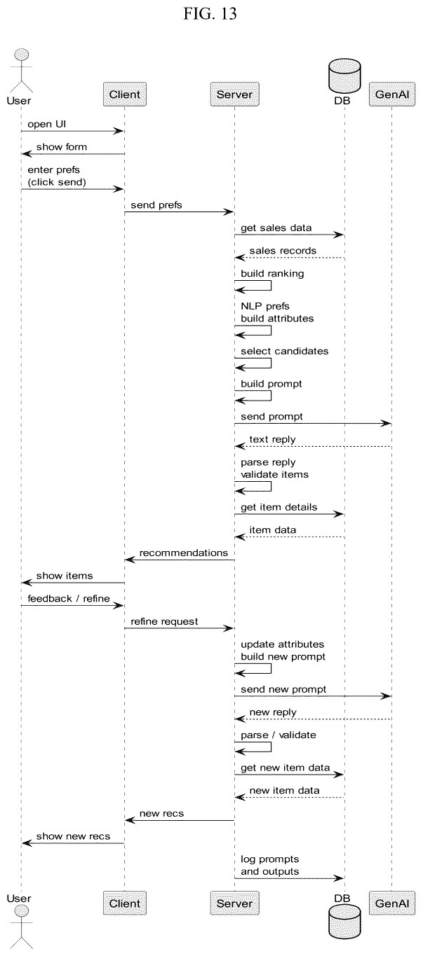

The following describes the processing flow using FIG. 13.

### Step 1

Server acquires sales trend information from an external aggregation storage.

Server receives, as input, transaction records including at least item identifiers, quantities, timestamps, and category attributes.

Server executes database queries to the external aggregation storage and loads the returned tabular data into main memory.

Server performs data aggregation by grouping records by item identifier, summing quantities, counting transactions, and computing time-decayed values using arithmetic operations.

Server outputs normalized sales statistics per item, including total sales, recent sales, and frequency measures, as an intermediate dataset in memory.

### Step 2

Server computes a sales index for each item and constructs ranking information.

Server receives, as input, the aggregated sales statistics from Step 1.

Server applies a numerical formula that multiplies each statistic by a predetermined weight and sums the results to obtain a composite sales index for each item.

Server normalizes the indices, for example by dividing by the maximum value or applying z-score normalization, and sorts the items in descending order of the sales index.

Server outputs ranking information as a structured table containing item identifiers, sales indices, ranking positions, and selected item attributes, and writes this table to a storage device.

### Step 3

Server updates ranking information periodically based on new sales trend information.

Server receives, as input, an update trigger and incremental transaction records with timestamps later than a stored update time.

Server recomputes the sales index only for items affected by the new records, using the same weighting and normalization functions as in Step 2, and updates the corresponding rows in the ranking table.

Server maintains and updates index structures on the ranking table to ensure efficient retrieval by style, color, and ranking position.

Server outputs an updated ranking information dataset with minimal recomputation cost.

### Step 4

Terminal initializes a user interface for inputting preference information.

Terminal receives, as input, configuration data for available options such as style categories, color codes, body-type categories, and budget ranges.

Terminal constructs graphical components including text fields, selection lists, toggle controls, and buttons, and renders these components on a display unit.

Terminal outputs a visible input screen that is ready to accept user interactions and captures any subsequent touches, clicks, or keyboard events as input events.

### Step 5

User provides initial preference information through the terminal.

User receives, as input, the visual prompt on the terminal asking for style, color, and other preferences.

User types at least one natural language sentence, such as “I want a casual style with blue items for a slim body type,” and optionally selects additional options such as “mid-range budget” or “weekend outing.”

User triggers a submission operation by activating a send button or an equivalent control on the terminal.

User outputs preference information as a combination of natural language text and structured selections to the terminal.

### Step 6

Terminal packages the user preference information and transmits it to the server.

Terminal receives, as input, the natural language sentence and the structured selections generated in Step 5.

Terminal constructs a request message that includes user identifiers, the raw text string, and encoded values for the structured options, and serializes this message into a network-transmittable data format.

Terminal sends the serialized request to the server via a network interface using a communication protocol such as HTTP over a secure transport.

Terminal outputs a structured preference request that becomes the input of the server-side processing pipeline.

### Step 7

Server parses the natural language preference information and generates attribute information.

Server receives, as input, the preference request containing the raw text and the structured selections from Step 6.

Server invokes a language processing module that tokenizes the raw text, assigns part-of-speech tags, and performs semantic analysis to extract candidate attributes such as style, color, body type, occasion, and budget.

Server resolves conflicts between extracted attributes and structured selections by applying predetermined precedence rules, and maps final attribute values to normalized codes or vectors.

Server outputs attribute information as a structured object consisting of normalized style, color, body-type, and other preference codes.

### Step 8

Server selects candidate items from the ranking information based on the attribute information.

Server receives, as input, the attribute information from Step 7 and the ranking information from Step 2 or Step 3.

Server executes queries against the ranking table to retrieve items that match basic constraints such as style code and color code, and orders the retrieved items by their sales indices.

Server applies additional filters in application logic, such as excluding items with incompatible fit types for a given body-type code or removing items that do not satisfy a budget range.

Server outputs a candidate set of items, including item identifiers, key attributes, and ranking positions, as a filtered and ordered subset of the ranking information.

### Step 9

Server generates a prompt sentence for a generative AI model using the candidate set and attribute information.

Server receives, as input, the candidate item set from Step 8 and the attribute information from Step 7.

Server formats user preference attributes into text segments, such as “style=casual; main color=blue; body type=slim; occasion=weekend outing,” and converts item attributes into compact textual descriptions.

Server assembles these segments into a prompt sentence according to predefined generation rules that specify section order, maximum number of candidate items, and wording pattern.

Server outputs a complete prompt sentence, for example:

“User preferences: style=casual; main color=blue; body type=slim; occasion=weekend outing.

Bestseller data (top 10 items):
1. ID 101: blue denim jacket, slim fit, high popularity.
2. ID 205: navy hoodie, regular fit, mid-range price.

Task: As a fashion recommendation assistant, using the above bestseller data, recommend 5 specific items that best match the user's preferences. For each item, return the item ID and one sentence explaining why it fits the user's profile and current trends.”

### Step 10

Server invokes the generative AI model with the prompt sentence and obtains recommendation candidate information.

Server receives, as input, the prompt sentence from Step 9.

Server converts the prompt sentence into a sequence of tokens using a tokenizer associated with the generative AI model and sends the token sequence and model parameters (such as temperature and maximum output length) to an inference engine running on a computation accelerator.

Server receives, as output from the inference engine, a sequence of generated tokens that encode recommendation candidate information, interprets the tokens as text, and reconstructs the model output as a readable string.

Server outputs raw recommendation candidate information in textual form, including proposed item identifiers, explanations, and any grouping indications.

### Step 11

Server parses and validates the recommendation candidate information against the ranking information.

Server receives, as input, the raw recommendation candidate text from Step 10 and the candidate item set or ranking information from Step 8.

Server applies pattern matching or structured parsing rules to extract item identifiers and associated explanation fragments from the text, and creates a provisional recommendation list.

Server compares each extracted item identifier to the items present in the candidate set or ranking information, discards or corrects invalid identifiers, and removes duplicates to ensure consistency and availability.

Server outputs a validated recommendation list containing item identifiers and associated explanation texts aligned with the stored item catalog.

### Step 12

Server enriches the validated recommendation list with detailed item information and constructs recommendation information.

Server receives, as input, the validated recommendation list from Step 11.

Server queries the item database for each item identifier in the recommendation list to obtain details such as item name, category, price, available sizes, and media references.

Server associates the retrieved details with the corresponding explanation texts and optionally groups items into coordination candidates based on compatibility rules or group tags included in the AI output.

Server outputs recommendation information as a structured dataset ready for presentation, containing full item descriptions, prices, image references, and explanation information.

### Step 13

Server transmits the recommendation information to the terminal.

Server receives, as input, the structured recommendation information from Step 12.

Server serializes this information into a response message and attaches metadata such as a session identifier, grouping labels, and timestamps.

Server sends the response message to the terminal via the communication interface using a network protocol.

Server outputs transmitted recommendation information that becomes the input for the terminal's presentation processing.

### Step 14

Terminal renders a visual proposal screen using the recommendation information.

Terminal receives, as input, the recommendation information from Step 13.

Terminal downloads or retrieves image data for each item using the media references, arranges item tiles or panels on the display, and visually separates coordination candidates into distinct sections.

Terminal overlays explanation texts, prices, and other details near the corresponding images, and activates interactive elements such as “select,” “customize,” and “show more” controls.

Terminal outputs a visual proposal screen and registers event handlers so that subsequent user interactions become input events for further processing.

### Step 15

User evaluates the proposed items and provides feedback and customization inputs.

User receives, as input, the visual proposal screen from Step 14.

User examines images and texts, selects one or more items or coordination candidates, rejects items by invoking removal controls, and adjusts parameters such as size or color variations through the provided controls.

User may also enter additional natural language feedback, such as “Show me similar casual blue items but slightly warmer for early spring, and keep a slim fit.”

User outputs evaluation information and additional preference information to the terminal through selection operations, customization operations, and text inputs.

### Step 16

Terminal packages the evaluation information and additional inputs and sends a refinement request to the server.

Terminal receives, as input, the user's selections, rejections, customizations, and any additional natural language text from Step 15.

Terminal encodes liked item identifiers, disliked item identifiers, modified attributes, and new text into a structured refinement message that includes the current session identifier.

Terminal transmits the refinement message to the server via the communication interface.

Terminal outputs a refinement request that triggers iterative recommendation processing on the server side.

### Step 17

Server updates attribute information based on the refinement request and generates a revised prompt sentence.

Server receives, as input, the refinement request from Step 16 and the current attribute information from Step 7.

Server modifies the attribute information by incorporating evaluation data, for example, adding a season attribute indicating “early spring” and a material attribute indicating “warmer fabric,” and adjusting weights for liked or disliked styles.

Server retrieves a filtered candidate set from the ranking information that satisfies the updated attributes and constructs a revised prompt sentence that describes previously liked and disliked items, the new preferences, and the filtered bestseller data.

Server outputs a revised prompt sentence, for example:

“User previously liked items 101 and 205 (casual blue jacket and hoodie) and disliked items 309 and 412 (too light for early spring).

User now says: ‘Show me similar casual blue items but slightly warmer for early spring, and keep a slim fit.’

Filtered bestseller data (warmer casual blue items suitable for early spring):
1. ID 150: lined denim jacket, slim fit, medium weight.
2. ID 260: fleece-lined hoodie, slim fit, warm fabric.

Task: Propose 5 new items that are warmer than the disliked items, maintain a casual blue style for a slim body type, and avoid lightweight fabrics. For each item, return the item ID and one-sentence reasons.”

### Step 18

Server feeds the revised prompt sentence to the generative AI model and generates updated recommendation candidate information.

Server receives, as input, the revised prompt sentence from Step 17.

Server performs tokenization, sends tokens and model parameters to the inference engine, and requests new generated output.

Server receives an updated sequence of tokens, reconstructs them into text, and interprets the text as updated recommendation candidate information including new item identifiers and explanations.

Server outputs updated recommendation candidate information that will be validated and enriched in the same manner as in Steps 11 and 12.

### Step 19

Server logs prompt sentences, model outputs, and interaction data for offline analysis and system optimization.

Server receives, as input, the original prompt sentences from Step 9, the revised prompt sentences from Step 17, the corresponding model outputs from Steps 10 and 18, and interaction data such as selections and rejections from Steps 13 and 16.

Server stores these data elements as log records in a dedicated log table or log storage area, linking each record to a session identifier and timestamps.

Server periodically retrieves the log data, computes statistics such as selection rates and correction frequencies, and adjusts prompt generation rules and model operation parameters in configuration storage based on these statistics.

Server outputs updated configuration data that influence subsequent executions of Steps 9, 10, 17, and 18, thereby improving the efficiency and quality of future recommendation cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation engines generally treat a user's preference data, current catalog data, and any conversational context as loosely coupled inputs to a rule-based or static machine learning pipeline. In such systems, an application server typically retrieves product data from a database, applies fixed filtering and ranking logic, and returns a list of items to a client device. This architecture has several technical drawbacks when deployed in interactive, real-time fashion recommendation scenarios.

First, conventional systems are not architected to exploit large-scale generative AI models through explicit, systematically constructed prompt sentences that integrate heterogeneous state information. In many existing implementations, calls to a generative model are ad hoc, with unstructured prompts that merely restate the user's latest query. As a result, the generative model cannot effectively leverage structured sales trend information, historically observed user attributes, or past interaction context. This leads to suboptimal utilization of computing resources: the server expends CPU and network bandwidth to invoke a large model, yet the model operates on incomplete or noisy context, reducing the technical efficiency of the overall pipeline.

Second, existing systems rarely incorporate multimodal emotion recognition in a way that is tightly coupled with the generative recommendation loop at the server level. Although separate emotion-recognition components exist, conventional architectures typically process image and audio data at the client or in standalone services, and then pass only coarse labels to the application logic. These labels are not systematically integrated into the generation of machine-readable instructions to a generative AI model. Consequently, the emotion signals are not fed back into the ranking, filtering, or prompt-construction stages in a structured manner, and the system cannot dynamically adapt model behavior based on real-time emotion states while maintaining a coherent server-side control flow.

Third, many interactive fashion systems handle augmented reality (AR) or virtual try-on as an independent client-side visualization feature, decoupled from the core recommendation logic. The server usually returns static images or product identifiers, and the client attempts to overlay them in AR without server coordination regarding which items are suitable for AR, how they should be parameterized for overlay, or how AR interaction should influence subsequent recommendations. This separation not only fragments state management but also causes redundant computations and inconsistent experiences across devices, as each client must locally deduce how to align recommended items with body-tracking data.

Fourth, current platforms often lack a structured mechanism to iteratively refine recommendation quality by accumulating user operation information and evaluation feedback at the server, and then encoding such feedback into subsequent prompts to the generative AI model. Without a persistent, server-managed loop that updates user attribute information and emotion state information and re-invokes the model with updated prompt sentences, the system cannot efficiently converge on better proposals in a single session. The computational pipeline thus fails to exploit prior in-session context, leading to repeated, stateless generations that are less relevant and more resource-consuming.

Accordingly, there is a need for an improved computer-implemented system that: (i) systematically acquires and integrates sales trend data, user attribute data, and multimodal emotion state data at the server; (ii) converts these heterogeneous data into structured, text-format prompt sentences that precisely instruct a generative AI model to perform constrained, structured recommendation tasks; (iii) analyzes the model's output to derive machine-usable item identifiers and explanation data; (iv) manages AR/virtual try-on overlay data generation at the server side based on the same shared state; and (v) iteratively updates user and emotion models based on feedback, thereby improving the technical performance, consistency, and adaptability of the overall recommendation pipeline implemented on general-purpose computing hardware.

The specific processing by the specific processing unit 290 of the data processing device 12 in Application Example 2 is realized by the following means.

The present invention provides a server comprising a processor and an information storage device, the processor being configured to obtain item-related information including user attribute information and sales trend information from the information storage device; to generate, based on the obtained item-related information and interaction content with a user, a text-format prompt sentence including instruction content for a generative AI model to execute a proposal process for the user; to acquire, as the user attribute information, preference information, physique information, budget information, and past selection history of the user, compare the user attribute information with the sales trend information, and generate a prompt sentence including condition information for specifying candidates of proposal content by the generative AI model; to generate emotion estimation data to be input to an emotion recognition model by using image information and audio information of the user acquired from an imaging device and an audio acquisition device, obtain emotion state information from the emotion recognition model, and generate, based on the emotion state information, a prompt sentence for instructing adjustment conditions of the proposal content to the generative AI model; to analyze proposal result data output from the generative AI model to extract item identification information and description information, obtain image information corresponding to the item identification information from the information storage device, generate display data in association with the proposal result data, and present the item-related information visually via a display device; to update the user attribute information and the emotion state information based on operation information and evaluation information transmitted from a user terminal, and repeatedly execute the proposal process by generating a new prompt sentence reflecting the updated information and inputting the new prompt sentence to the generative AI model; and to generate superimposed-display data for an augmented-reality display process or a virtual try-on display process based on the item identification information and the physique information of the user, and output control information for presenting the item-related information superimposed on a real-space image or a virtual-space image on a display device of a terminal device. This enables a coordinated, server-centric processing pipeline in which heterogeneous user, product, and emotion data are normalized and encoded into structured prompt sentences for a generative AI model, the model's outputs are converted back into machine-usable identifiers and AR overlay parameters, and iterative feedback from the user is incorporated into subsequent prompts, thereby improving computational efficiency, recommendation relevance, and consistency of multimodal presentation across devices in a computer-implemented fashion recommendation environment.

The term “processor” refers to a hardware computation unit, such as a central processing unit or a dedicated processing circuit, that executes program instructions to perform data acquisition, analysis, and control operations in the system.

The term “information storage device” refers to a hardware storage unit, such as a memory device or a database apparatus, that stores item-related information, user attribute information, sales trend information, image information, and program data used by the processor.

The term “item-related information” refers to digital data describing one or more items, including at least item identification information, attribute information, price information, and image information, which are used for generating proposal content.

The term “user attribute information” refers to digital data representing characteristics of a user, including preference information, physique information, budget information, and past selection history that influence proposal generation.

The term “sales trend information” refers to digital data indicating popularity or sales performance of items over a period of time, including at least sales volume, ranking, or other metrics that reflect market trends.

The term “preference information” refers to data representing a user's favored styles, colors, categories, or other item attributes indicated explicitly by the user or inferred from user behavior.

The term “physique information” refers to data representing physical characteristics of the user, such as height, weight, body shape, or size information, which is used to select items appropriate to the user's body.

The term “budget information” refers to data representing a monetary range or constraint specified or inferred for the user, indicating allowable price levels for items to be proposed.

The term “past selection history” refers to data indicating items previously selected, purchased, or positively evaluated by the user, together with associated timestamps or contexts.

The term “interaction content” refers to data representing verbal, textual, or operational exchanges between the user and the system, including user queries, responses, and interface operations.

The term “prompt sentence” refers to a text-format instruction sequence generated by the processor and supplied to a generative AI model to specify conditions, constraints, and tasks for producing proposal content.

The term “generative AI model” refers to a software-based machine learning model that generates textual or structured output based on an input prompt sentence, using learned parameters obtained from training data.

The term “condition information” refers to data specifying constraints, selection rules, or weighting parameters applied by the generative AI model or by subsequent processing to determine proposal candidates.

The term “emotion estimation data” refers to data derived from image information and audio information of the user and formatted as input to an emotion recognition model for determining the user's emotion state.

The term “emotion recognition model” refers to a software-based machine learning model that receives emotion estimation data and outputs emotion state information representing a detected emotional condition of the user.

The term “emotion state information” refers to data indicating an estimated emotional condition of the user, such as joy, sadness, neutrality, or other emotional categories, optionally with confidence scores.

The term “adjustment conditions” refers to information specifying how proposal content should be modified in response to the emotion state information, including changes in attribute priorities, styles, or presentation modes.

The term “proposal result data” refers to output data generated by the generative AI model in response to a prompt sentence, including item combinations, descriptions, and explanations.

The term “item identification information” refers to data that uniquely identifies an item within the system, such as an item identifier, code, or index used for retrieval from the information storage device.

The term “description information” refers to text or structured data describing characteristics, combinations, or usage of one or more items included in the proposal result data.

The term “image information” refers to digital data representing visual content of items or users, including still images or image sequences suitable for display or overlay.

The term “display data” refers to data formatted for output on a display device, including layout information, image references, text content, and interaction elements associated with proposal results.

The term “display device” refers to a hardware output unit, such as a screen or head-mounted display, that visually presents display data to the user.

The term “user terminal” refers to an electronic apparatus operated by the user, such as a mobile device, wearable device, or computing device, that communicates with the server and captures user input.

The term “operation information” refers to data representing user operations on the user terminal, including selections, button presses, scrolling actions, and other interface events.

The term “evaluation information” refers to data representing explicit or implicit user feedback on proposal content, such as like/dislike indications, ratings, comments, or purchase decisions.

The term “superimposed-display data” refers to data defining how item-related visual elements are overlaid on a base image or scene, including positional, scaling, and orientation parameters.

The term “augmented-reality display process” refers to a process in which digital item-related images are overlaid on a real-space image captured by an imaging device, in alignment with spatial or body-tracking information.

The term “virtual try-on display process” refers to a process in which digital representations of items are composited with a user image or avatar in a virtual-space image to simulate the user wearing the items.

The term “real-space image” refers to an image captured from a physical environment by an imaging device, representing the actual scene surrounding the user.

The term “virtual-space image” refers to an image generated or rendered by a computing device that represents a synthetic or simulated environment, including an avatar or reconstructed user body.

The term “terminal device” refers to a user-operable computing device, which may serve as the user terminal, equipped with at least one display device and capable of communicating with the server.

The term “weighting parameters” refers to numerical values or analogous indicators assigned to attributes such as brightness, saturation, silhouette, fit feeling, or category, which influence selection or ranking of items.

In one embodiment, a server, a terminal, and a user cooperate to implement the claimed system. The server comprises at least one processor, a memory, a non-volatile storage device, and a network interface. The terminal comprises at least one processor, a display device, an imaging device, an audio acquisition device, and a communication interface. The user operates the terminal and provides preferences, body-related information, feedback, and emotion-indicative inputs.

The server executes an application program implemented, for example, in a high-level language on an operating system. The server uses a relational database management system, such as an SQL-based database, as the information storage device that stores item-related information, user attribute information, sales trend information, image information, and interaction logs. The server provides an application programming interface over a communication network, using a web application framework, so that the terminal can send and receive structured data.

The server stores item-related information in the database using normalized tables. In one configuration, the server stores item records with fields such as item_id, category_code, style_code, color_code, size_code, price_value, popularity_score, image_resource_id, and availability_flag. The server stores sales trend information as time-series records containing, for each item_id and time interval, aggregated sales_volume, conversion_rate, and ranking_position. The server stores user attribute information in a user profile table with fields such as user_id, preference_vector, physique_vector, budget_range, and selection_history_reference.

The server represents the preference_vector and physique_vector as numeric feature vectors. For example, the server encodes style preferences as one-hot or multi-hot vectors over style codes; encodes color preferences as weighted values over color codes; encodes physique-related information as normalized numerical values representing height, weight, body-mass index, and discrete size categories. The server computes these vectors by applying scaling and encoding functions to the raw data received from the terminal.

The server maintains sales trend information by periodically executing SQL aggregation queries on transaction logs. The server computes popularity_score by applying a mathematical function that combines recent sales_volume, click-through rate, and recency weighting. This pre-processing reduces the computational burden at recommendation time and enables faster matching between user attributes and sales trend information.

The server implements an emotion recognition model as a separate software module. In one embodiment, the server uses a convolutional neural network for image-based emotion classification and a recurrent neural network or transformer-based network for audio-based emotion classification. The server applies a late-fusion architecture, in which the server computes an image-based emotion probability vector and an audio-based emotion probability vector and combines them using a weighted sum or another fusion function to produce emotion state information. The server stores the weights of these neural networks in the memory and loads them into the processor at runtime.

The server configures the image-based network with multiple convolutional layers, batch-normalization layers, pooling layers, and fully connected layers. The server uses facial landmark alignment and normalization as a pre-processing step, so that the network receives standardized face-region images at a fixed resolution. The server configures the audio-based network to operate on Mel-frequency cepstral coefficient features or spectrogram patches derived from the user's speech segments. During training, the server uses a labeled dataset of facial expressions and vocal recordings, optimizes a cross-entropy loss function, and updates the network weights by a gradient descent algorithm with backpropagation. The server optionally uses data augmentation, such as random cropping, brightness variation, and noise injection, to improve robustness.

The server executes this emotion recognition model when the terminal transmits image information and audio information captured from the user. The server converts raw pixel values and raw audio samples into the defined feature representations, feeds them into the networks, and obtains emotion state information in the form of probability distributions over discrete emotion labels such as joy, sadness, neutrality, surprise, or anger. The server then maps the highest-probability label and confidence value to an internal emotion_state_code that is stored in the database together with a timestamp.

The server executes a generative AI model as a text-generation engine. In one embodiment, the server connects to a generative AI model implemented as a transformer-based language model deployed on a separate inference system. The server treats the generative AI model as a sequence-to-sequence mapping from a prompt sentence to a textual response. The generative AI model has an architecture comprising multiple attention layers, feed-forward layers, and layer-normalization components, and it has been trained in advance using large-scale text corpora with a language modeling objective. In some variants, the server fine-tunes the generative AI model on domain-specific text including fashion descriptions and style guides.

The server constructs prompt sentences that encode heterogeneous system state information into a single, structured text instruction. The server does not merely forward the user's latest textual input; instead, the server composes the prompt sentence from the user attribute information, sales trend information, and emotion state information in a consistent, rule-based manner. For example, the server generates a prompt sentence such as:

“The user prefers a casual style and the preferred color is blue. The user's height is 170 cm and the usual size is medium. The budget is 10,000. The current emotion state is joy. The user previously selected relaxed-fit jackets and disliked tight-fit jackets. The following are hot-selling items: (1) item_id=1001, casual blue denim jacket, size M, price 8,000, popularity score 0.95; (2) item_id=1002, casual blue T-shirt, size M, price 3,000, popularity score 0.90; (3) item_id=1003, white sneakers, size 27, price 9,000, popularity score 0.88. Based on this information, propose three complete outfits using one or more of these items or similar items, suitable for a casual weekend outing. For each outfit, output: (a) a list of item_ids, (b) a short description, and (c) a brief explanation of why the outfit matches the user's preference, physique, and joyful emotion.”

In another example, the server generates an emotion-sensitive prompt sentence such as: “The user prefers a minimalist style and neutral colors. The user's height is 160 cm and the body type is petite. The current emotion state is sadness. Based on the latest sales trend information for minimalist, neutral-colored items, suggest three calm and comfortable outfits that may gently improve the user's mood, avoiding overly flashy designs. For each outfit, specify item_ids and provide a short explanation of the selection.”

The server also generates prompts that reflect user feedback collected during the session. For instance, when the user negatively evaluates a previously proposed jacket, the server modifies subsequent prompt sentences as follows:

“The user disliked the previous tight-fit jacket and requested a looser jacket. The user prefers a casual style, blue color, and a medium size for a height of 170 cm. The current emotion state is neutral. Using the following hot-selling items: (1) item_id=2001, relaxed-fit blue jacket; (2) item_id=2002, blue hoodie; (3) item_id=2003, loose-fit jeans, propose two alternative casual blue outfits with a relaxed fit. Output item_ids, descriptions, and reasons.” By encoding structured instructions and constraints into the prompt sentences in this fashion, the server constrains the generative AI model to perform specific, machine-usable tasks. The server then parses the textual outputs according to expected patterns, extracting item identifiers, descriptions, and explanations. The server applies deterministic parsing rules or simple natural-language tagging techniques to map the generated text back into structured data objects, which the server aligns with the item-related information stored in the database. The server uses this structure to avoid ad hoc free-form text that would be difficult to integrate into downstream modules. Instead, the server uses pre-defined output formats in the prompt sentences, thereby enabling reliable extraction of item lists and associated attributes. This design reduces processing errors, improves computational efficiency, and enhances the determinism of the recommendation pipeline compared to conventional generative text usage. The server stores operation information and evaluation information received from the terminal as feedback records. The server computes updated weighting parameters for style attributes such as brightness, saturation, silhouette type, fit feeling, and category. The server models these weighting parameters as numeric coefficients in a multi-dimensional attribute space. The server updates these coefficients using an incremental learning rule, for example, by shifting weights toward attributes associated with positively evaluated items and away from attributes associated with negatively evaluated items. The server then encodes these updated coefficients back into condition information that is explicitly inserted into subsequent prompt sentences.

The server manages augmented reality and virtual try-on display processes coherently with the recommendation process. The server associates each item_id with AR-related metadata, such as 3D model identifiers, mesh parameters, anchor points, and body-region tags. When the generative AI model proposes an outfit, the server also aggregates the corresponding AR metadata and generates superimposed-display data that specifies how the items should be positioned and scaled relative to a detected body skeleton or avatar. The server does not rely on the terminal to infer these relationships independently; instead, the server computes transformation parameters, scaling factors, and recommended overlay regions using body measurement data from the user attribute information.

The terminal performs imaging and audio acquisition using the built-in camera and microphone. The terminal encodes captured images and audio in a compressed format suitable for network transmission and sends them to the server. The terminal displays user interface elements that allow the user to input style preferences, color preferences, body measurements, and budget constraints, as well as to supply evaluation information, such as “like”, “dislike”, or commentary text. The terminal presents recommended outfits as image thumbnails and textual summaries received from the server, and in some embodiments, the terminal executes an AR engine (such as a mobile AR framework) to overlay clothing images or 3D models onto a live camera feed, based on superimposed-display data generated by the server.

The terminal also displays explanatory text produced by the generative AI model, such as: “Blue denim jacket over a blue T-shirt with white sneakers. This outfit matches the user's preference for casual blue items, fits a 170 cm body with medium size, and complements the user's joyful mood with bright and energetic colors.”

This explanation helps the user understand the rationale for each recommendation and provides an interface for more granular feedback, which the terminal transmits back to the server.

This architecture produces technical effects beyond mere automation of human selection. The server reduces network traffic and computational load on the terminal by centralizing heavy-weight operations, including database queries, emotion-model inference, generative model interactions, and AR parameter generation. The server improves processing speed and responsiveness because the server pre-computes sales trend metrics and stores user attribute vectors in optimized structures, allowing efficient SQL retrieval and vector operations. The server improves accuracy of recommendations by tightly integrating multimodal emotion signals and iterative user feedback into the prompt-construction process, which guides the generative AI model to produce more relevant and constrained outputs.

The server enhances data management by maintaining consistent item identifiers, AR metadata, user profiles, and interaction histories in a unified schema. The server improves computational efficiency by generating concise yet information-rich prompt sentences that avoid redundant or irrelevant data, thereby reducing the number of tokens processed by the generative AI model and decreasing latency and resource consumption. Because the server uses explicit output formats and condition information in the prompts, the server avoids repeated post-processing errors and reduces the need for complex natural language understanding modules.

The generative AI model in this system is not used as a black-box decision maker; instead, the server constrains and steers its behavior by embedding non-conventional, rule-based prompt structures that incorporate structured condition information, emotion-dependent weighting, and AR-aware constraints. This type of integration enables processing patterns that are not feasible with manual, human-only workflows, such as real-time reconfiguration of attribute weights and AR overlay parameters based on continuous sensor data and interaction histories.

In an alternative embodiment, the server hosts the generative AI model locally on a specialized hardware accelerator, such as a graphics processing unit or tensor processing unit. The server then performs inference without relying on an external service, and the server can apply custom decoding strategies, such as constrained beam search with attribute masks, to further ensure that generated outputs conform to the required structured format. The server may also maintain separate generative AI models tuned for different categories, such as apparel upper-body items, lower-body items, or accessories, and select an appropriate model instance based on the user's query and category-level preferences.

In another embodiment, the server employs a hybrid recommendation pipeline in which a non-generative ranking model pre-selects a candidate set of items using a gradient-boosted decision tree model or a collaborative filtering model, and the generative AI model only composes outfits and explanations from this candidate set. This hybrid structure reduces the search space and speeds up the overall proposal generation. The server passes the identifiers and attributes of the candidate items into the prompt sentences, as described above, so that the generative AI model operates on a curated set of items. This configuration improves both computational efficiency and recommendation precision.

In another variation, the server adapts the emotion recognition model parameters or fusion weights over time based on aggregate feedback. When users frequently reject recommendations produced during a specific emotion state, the server adjusts the mapping from emotion labels to attribute weighting parameters, thereby tuning the system to better correlate emotion states with actual user choices. This adaptation is implemented by adjusting numeric parameters stored in the database and referenced in the prompt-construction logic, thus directly affecting the generated prompt sentences and downstream generative AI model behavior.

In all of these embodiments, the server, the terminal, and the user form an integrated system in which the server performs structured data processing, algorithmic fusion of multimodal sensor data, and controlled interaction with a generative AI model via carefully constructed prompt sentences. The combination of database-backed item-related information, vectorized user profiles, neural-network-based emotion recognition, generative AI models constrained by explicit prompts, and AR metadata generation results in a technical improvement to computer-based recommendation systems, including faster response times, higher relevance, improved consistency of multimodal display, and reduced computational and communication overhead compared to conventional architectures.

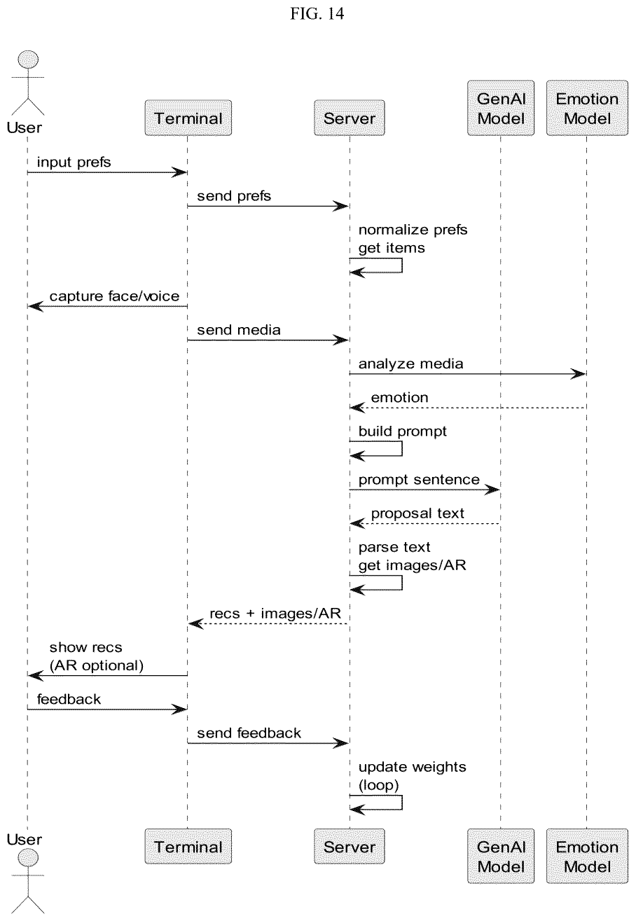

The following describes the processing flow using FIG. 14.

### Step 1

User operates the terminal to start the application and provide initial inputs.

User inputs style preference (for example, “casual”), color preference (for example, “blue”), physique information (for example, height and typical size), and budget information through graphical controls on the terminal.

The input of this step is raw interaction data such as text strings, numerical values, and selection events entered on the terminal user interface.

The output of this step is a structured preference payload (for example, a set of key-value pairs) stored in the terminal's working memory and prepared for transmission to the server.

### Step 2

Terminal generates and transmits a preference request to the server.

Terminal serializes the structured preference payload into a request message and attaches session identification information, device information, and optional free-text comments from the user.

The input of this step is the structured preference payload created in Step 1.

The terminal performs data formatting and encoding operations, such as converting native data structures into a network message format, to produce an output consisting of a network request sent over a communication channel to the server.

### Step 3

Server receives the preference request and normalizes user attribute information.

Server parses the request message to extract user preference data, physique data, and budget data, and validates each field against predefined ranges and allowed categories.

The input of this step is the network request containing user preference and physique information received from the terminal.

The server applies data conversion and mapping operations, such as mapping text labels to internal codes and scaling numeric values into normalized ranges, to produce as output a set of normalized user attribute vectors and corresponding records stored in an internal user profile or session table.

### Step 4

Server retrieves sales trend information and item-related information from the information storage device.

Server executes database queries that select items whose style, color, price, and size attributes are compatible with the normalized user attribute vectors.

The input of this step is the normalized user attribute vectors and associated codes created in Step 3.

The server performs data retrieval and filtering operations using relational queries and ranking calculations, thereby producing as output a candidate set of items with their attributes, popularity scores, and image identifiers, held in server memory for subsequent processing.

### Step 5

Terminal captures image information and audio information representing the user's current state.

Terminal activates the imaging device and the audio acquisition device after obtaining permission, and records a short segment of the user's face and voice, or captures static images if no speech is provided.

The input of this step is the user's physical appearance and voice in the real environment, as observed by the terminal sensors.

The terminal converts the analog sensor signals into digital image frames and audio samples, compresses them if necessary, and outputs a sensor data payload that is transmitted to the server.

### Step 6

Server performs emotion recognition based on the received sensor data.

Server decodes the image and audio data, applies pre-processing (such as face detection and feature extraction), and feeds the processed data into an emotion recognition model consisting of neural network components.

The input of this step is the sensor data payload containing the digital images and audio captured in Step 5.

The server carries out feature extraction operations (for example, generation of facial embeddings and audio feature vectors) and applies forward passes through the neural network layers, which results in an output comprising emotion state information in the form of probability values and an associated emotion label stored in the session context.

Step 7:

Server composes a prompt sentence for the generative AI model using aggregated context.

Server collects normalized user attribute vectors, the candidate item set from the database, and the emotion state information, and converts these heterogeneous data into a coherent natural language instruction.

The input of this step is the combination of user profile data, sales trend-based item candidates, and emotion state information created in the previous steps.

The server executes string assembly and template-filling operations, embedding item attributes and constraint conditions into a text structure, and outputs a prompt sentence that encodes explicit instructions and expected output format for the generative AI model.

### Step 8

Server sends the prompt sentence to the generative AI model and receives proposal result data.

Server transmits the constructed prompt sentence to a language-generation engine and controls generation parameters such as temperature, maximum output length, and decoding strategy.

The input of this step is the prompt sentence generated in Step 7.

The server causes the generative AI model to perform sequence processing and attention-based inference over the prompt tokens, and obtains, as output, a textual response that describes one or more item combinations, explanation text, and optionally a structured list of item identifiers.

### Step 9

Server parses the proposal result data to extract machine-usable recommendation structures.

Server analyzes the generated text, identifies segments that represent item identifiers, descriptions, and rationales, and matches item identifiers against the stored item-related information.

The input of this step is the raw textual response produced by the generative AI model in Step 8.

The server performs text segmentation, pattern matching, and lookup operations, transforming the free-form text into a structured recommendation list; the output consists of recommendation records that include item identification information, description information, and linkage to corresponding database entries.

### Step 10

Server acquires image information and AR metadata for recommended items.

Server queries the information storage device using the extracted item identification information to obtain associated image resources and, if available, 3D models and overlay parameters for augmented reality or virtual try-on.

The input of this step is the structured recommendation list containing item identifiers created in Step 9.

The server executes database retrieval and data-joining operations that combine visual resources and AR metadata with each recommendation entry, producing an output that consists of enriched recommendation data ready to be rendered visually and used in AR overlay processes.

### Step 11

Server updates user attribute information and internal weighting parameters based on current recommendations and previous feedback.

Server accesses historical evaluation information for the current user or session, adjusts numerical weighting parameters associated with style attributes, colors, silhouettes, and fit preferences, and associates these parameters with the present recommendation context.

The input of this step is the existing user profile data, recorded evaluation information, and the current set of recommended items.

The server performs vector update and parameter optimization operations (such as incremental adjustments toward attributes correlated with positive feedback), thereby outputting updated user preference vectors and revised weighting parameters that are stored in persistent storage and used in subsequent prompt construction.

### Step 12

Server compiles a response package containing recommendation data and control information for the terminal.

Server assembles the structured recommendation records, image references, AR overlay data, and any updated explanatory text into a unified response format.

The input of this step is the enriched recommendation data from Step 10 and the updated user-related parameters from Step 11.

The server applies serialization and formatting operations to create an output response message that is transmitted through the network interface to the terminal, including all information required for visual display and optional AR presentation.

### Step 13

Terminal renders recommendation results on the display device and optionally initiates AR or virtual try-on display.

Terminal decodes the response message, downloads referenced image resources if necessary, and arranges recommended items and explanations in an appropriate user interface layout; when AR-related data are included, the terminal activates its AR engine and aligns item overlays with the real-space or virtual-space image.

The input of this step is the response package received from the server in Step 12.

The terminal performs image loading, layout computation, and, when applicable, real-time transformation of AR overlays according to the control information, and outputs visual content on the display device in the form of recommendation lists, detailed views, or interactive AR try-on scenes.

### Step 14

User interacts with the displayed recommendations and provides operation information and evaluation information.

User selects outfits, expands item details, approves or rejects specific items, and may enter textual comments regarding fit, style, or mood.

The input of this step is the visual presentation and interactive controls shown on the terminal as produced in Step 13.

The user's actions produce an output in the form of discrete interface events and feedback data, which the terminal records as structured operation information and evaluation information to be transmitted back to the server, thereby closing the loop and enabling further iterations of the recommendation process.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

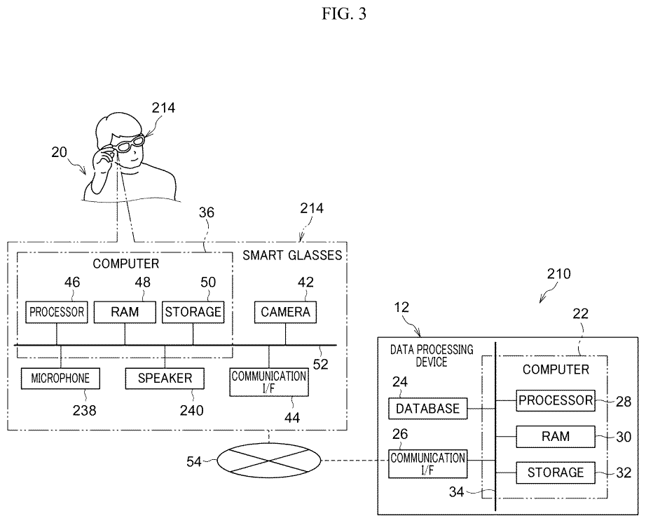

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

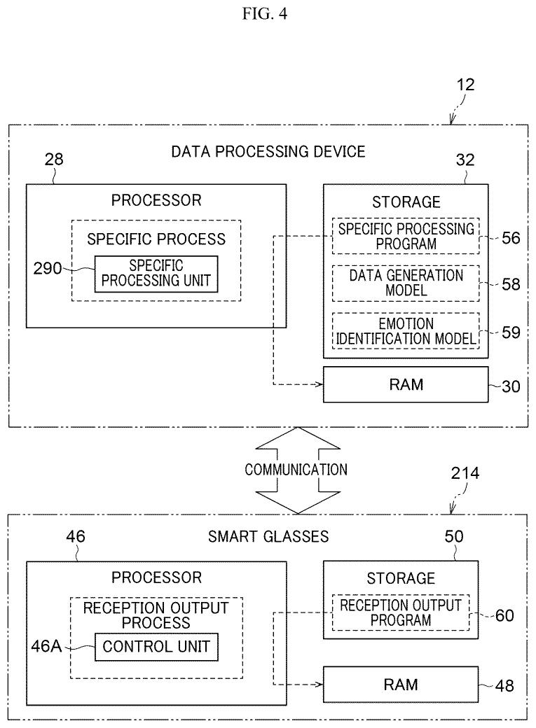

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

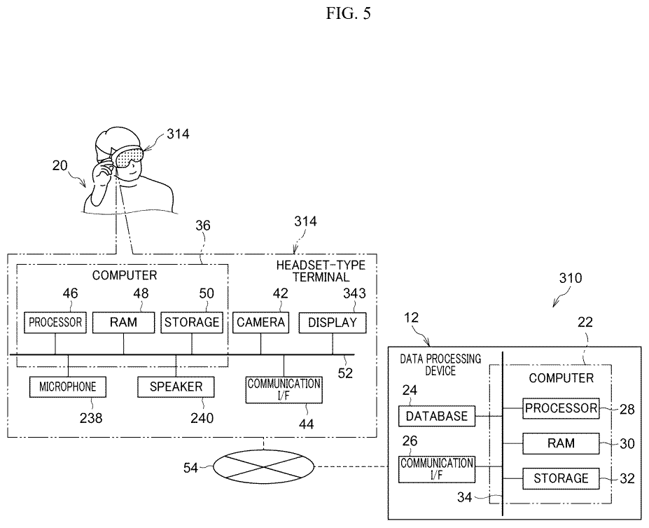

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

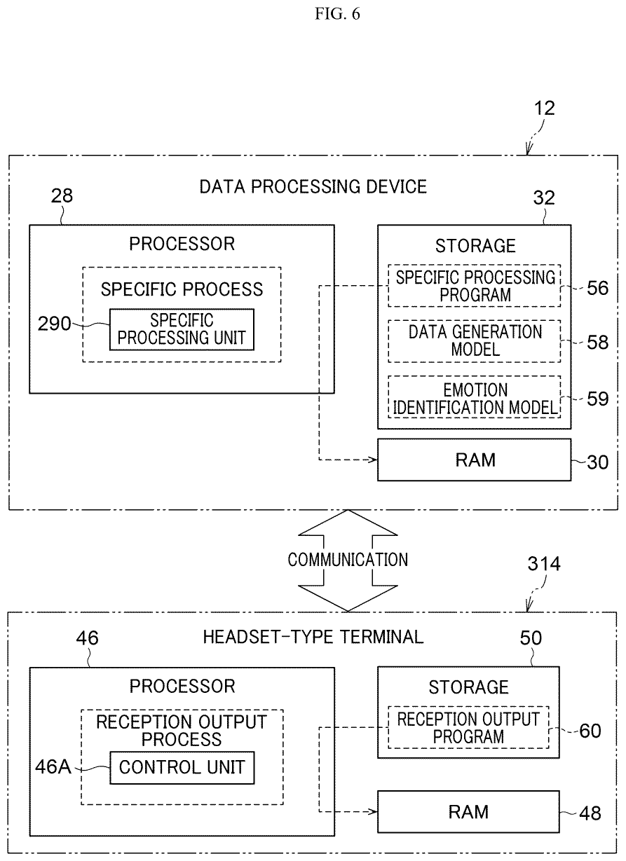

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

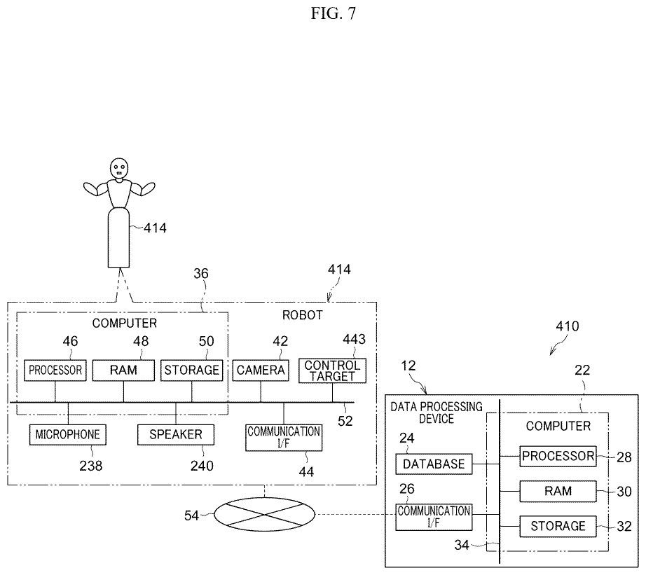

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

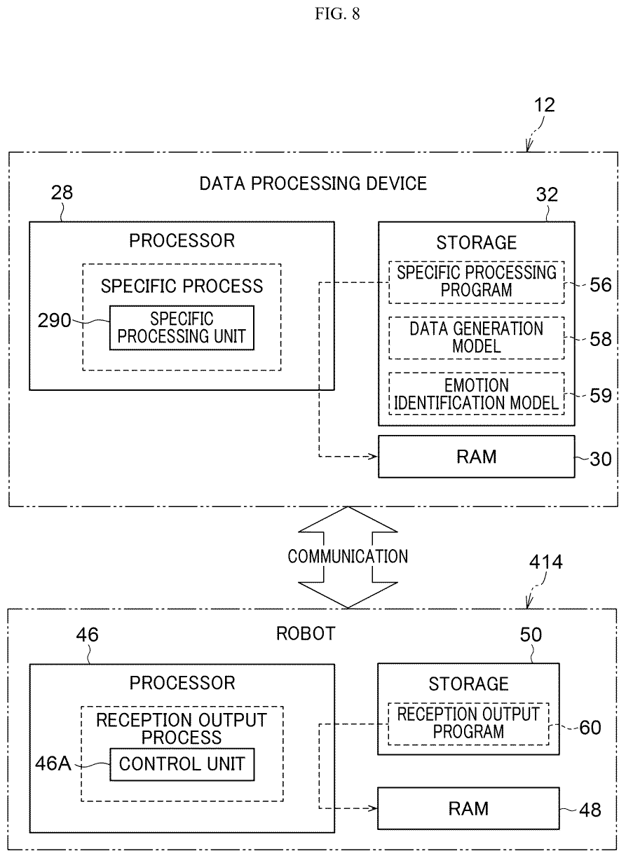

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

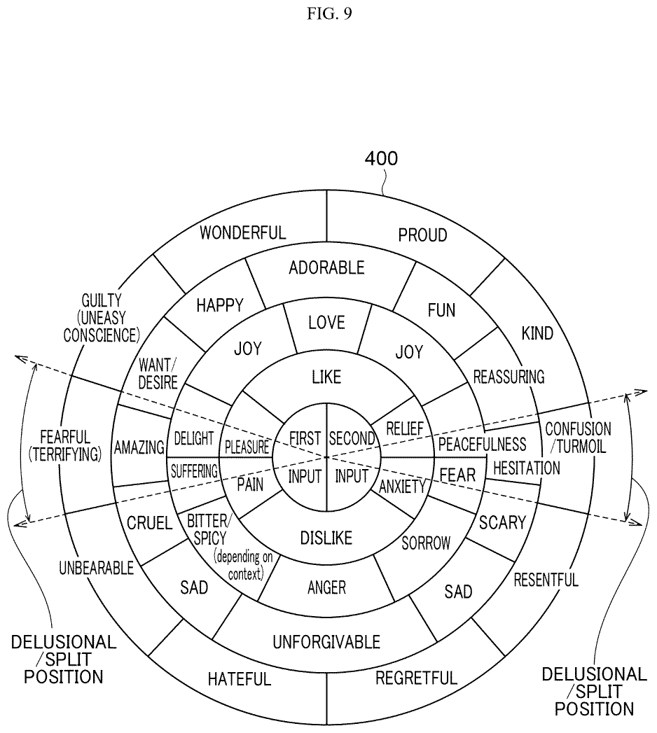

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

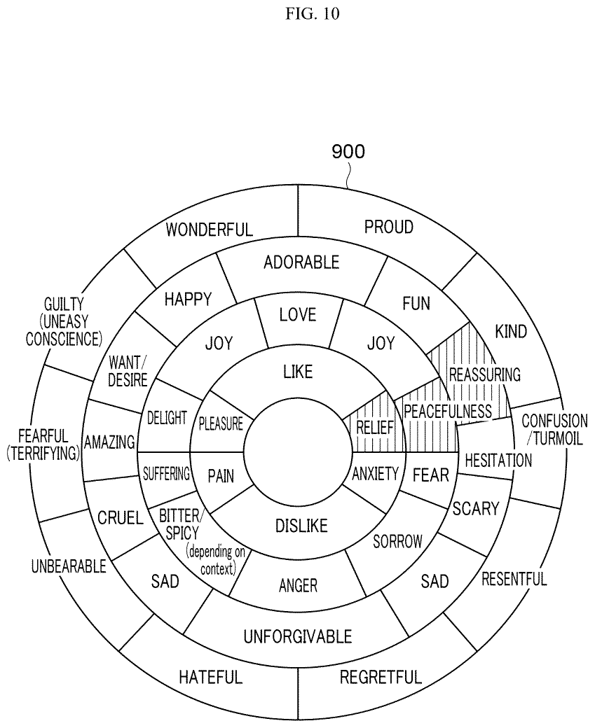

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire merchandise information including sales information from a storage information source, perform numerical processing and statistical processing on the acquired merchandise information, and generate distribution trend information based on the merchandise information,
receive, from a terminal device, input information including user attribute information and user preference information, convert the input information into structured information, and perform transmission and reception of digital information including the structured information via a communication path between the processor and the terminal device, generate, based on the distribution trend information and the input information, a prompt sentence expressed in a natural language for input to a generative artificial intelligence model and numerical feature information for input to the generative artificial intelligence model, and input the prompt sentence and the numerical feature information to the generative artificial intelligence model,
acquire, from the generative artificial intelligence model, relevance information and proposal content information calculated based on the prompt sentence and the numerical feature information, select and rank the merchandise information based on the relevance information, and generate proposal candidate information,
acquire image information corresponding to the proposal candidate information from an image storage device, generate display information including the proposal candidate information and the image information, transmit the display information to the terminal device, and cause the terminal device to perform visual display using the display information, update the input information based on change request information from a user acquired from the terminal device, regenerate the prompt sentence and the numerical feature information based on updated input information and the distribution trend information, and cause the generative artificial intelligence model to perform re-inference processing to regenerate the proposal candidate information, and
acquire state information relating to an emotional state of the user from the terminal device, and adjust at least one of the prompt sentence and the proposal candidate information based on the state information.

### Supplementary 2

The system according to supplementary 1,
wherein the processor is configured to acquire the sales information by using a relational information management apparatus or a similar information management apparatus, deploy the sales information as tabular data on a main storage apparatus, and generate the distribution trend information by performing data processing including aggregation processing, sorting processing, and extraction processing on the tabular data.

### Supplementary 3

The system according to supplementary 1,
wherein the processor is configured to cause the terminal device to generate a user display screen for inputting the user attribute information and the user preference information in response to a user operation, and to update the user display screen based on the proposal candidate information and the image information obtained through the generative artificial intelligence model, and to cause the terminal device to perform real-time display processing for visually displaying the proposal candidate information substantially immediately.

### Application Example 1

### Supplementary 1

A system comprising a processor,
wherein the processor is configured to
generate a prompt sentence that instructs extraction of candidates of apparel-related information to be presented to a user, based on user profile information including preference information and body information acquired from a user terminal, and sales trend information acquired from a sales performance information storage device,
generate a prompt sentence that instructs a generative AI model, given the prompt sentence including the user profile information and the sales trend information, to generate recommendation information including selection reasons for the candidates of the apparel-related information and combination proposals,
generate display data by associating the recommendation information output from the generative AI model with image information corresponding to the apparel-related information, and by transmitting the display data to the user terminal,
specify three-dimensional display data or superimposition display image data corresponding to target apparel-related information, based on an augmented reality display request and identification information of the target apparel-related information acquired from the user terminal, and transmit, to the user terminal, augmented reality data used for virtual try-on display by the user terminal,
and generate a prompt sentence that instructs improvement of generation accuracy of the recommendation information using the generative AI model, by storing evaluation information regarding the virtual try-on acquired from the user terminal, and by updating generation contents of the prompt sentence or weighting of the sales trend information based on the evaluation information.

### Supplementary 2

The system according to supplementary 1,
wherein the processor is configured to
update popularity indices for the apparel-related information based on the sales trend information acquired from the sales performance information storage device and the evaluation information, and generate the prompt sentence to be input to the generative AI model including the updated popularity indices.

### Supplementary 3

The system according to supplementary 1,
wherein the processor is configured to
generate the augmented reality data including control information for causing an augmented reality application executed by the user terminal, based on the user profile information and the augmented reality display request transmitted from the user terminal, to superimpose the three-dimensional display data or the superimposition display image data on a captured image, and to perform real-time virtual try-on display of the apparel-related information.

### Example 2

### Supplementary 1

A system comprising a processor, a storage device, and a terminal device, wherein the processor is configured to
acquire sales trend information from an external aggregation storage, calculate a sales index for each item based on the acquired sales trend information, and store, in the storage device, ranking information in which the items are ordered according to the sales index, obtain the ranking information and preference information expressed in natural language from a user via the terminal device, convert the preference information into attribute information by language processing, generate a prompt sentence including the ranking information and the attribute information, and input the prompt sentence to a generative AI model so as to cause the generative AI model to generate recommendation candidate information,
compare item identification information included in the recommendation candidate information output from the generative AI model with the ranking information, generate recommendation information to which item information and explanation information are added based on a comparison result, and transmit the recommendation information to the terminal device,
obtain evaluation information and additional natural language input of the user from the terminal device, update the attribute information based on the evaluation information and the additional natural language input, generate a revised prompt sentence including the updated attribute information and the ranking information, and input the revised prompt sentence to the generative AI model so as to sequentially update the recommendation candidate information, and
control the terminal device so that the terminal device generates a visual proposal screen using image information and explanation information included in the recommendation information, receives selection operations and customization operations for the items from the user, and transmits contents of the operations to the processor.

### Supplementary 2

The system according to supplementary 1,
wherein the processor is configured to
store the prompt sentence and the revised prompt sentence as log information in the storage device, analyze the stored log information, and update at least one of generation rules of the prompt sentence and operation conditions of the generative AI model based on a result of the analysis.

### Supplementary 3

The system according to supplementary 1,
wherein the processor is configured to
control the terminal device to classify the item information included in the recommendation information into a plurality of item groups, display the plurality of item groups as respective coordination candidates on the visual proposal screen, and visually distinguish the coordination candidates from one another.

### Application Example 2

### Supplementary 1

A system comprising a processor,
wherein the processor is configured to
obtain item-related information including user attribute information and sales trend information from an information storage device, and generate a text-format prompt sentence including instruction content for a generative AI model to execute a proposal process for a user based on the item-related information and interaction content with the user, acquire, as the user attribute information, preference information, physique information, budget information, and past selection history of the user, compare the user attribute information with the sales trend information, and generate a prompt sentence including condition information for specifying candidates of proposal content by the generative AI model,
generate emotion estimation data to be input to an emotion recognition model that performs emotion estimation processing using image information and audio information of the user acquired from an imaging device and an audio acquisition device, and generate a prompt sentence for instructing adjustment conditions of the proposal content to the generative AI model based on emotion state information obtained from the emotion recognition model, analyze proposal result data output from the generative AI model to extract item identification information and description information, obtain image information corresponding to the item identification information from the information storage device, generate display data in association with the proposal result data, and present the item-related information visually via a display device,
update the user attribute information and the emotion state information based on operation information and evaluation information transmitted from a user terminal, and repeatedly execute the proposal process by generating a new prompt sentence reflecting the updated information and inputting the new prompt sentence to the generative AI model, and generate superimposed-display data for an augmented-reality display process or a virtual try-on display process based on the item identification information and the physique information of the user, and output control information for presenting the item-related information superimposed on a real-space image or a virtual-space image on a display device of a terminal device.

### Supplementary 2

The system according to supplementary 1,
wherein the processor is configured to
enumerate, in the text-format prompt sentence, attribute information of a plurality of item candidates extracted as the sales trend information and combination conditions of the item candidates, and instruct the generative AI model to output, in a structured format, a predetermined number of item combinations selected from the item candidates and an explanation sentence for each item combination.

### Supplementary 3

The system according to supplementary 1,
wherein the processor is configured to
update weighting parameters relating to brightness, saturation, silhouette, fit feeling, or category based on the emotion state information estimated by the emotion recognition model and the evaluation information, and dynamically adjust the proposal content by the generative AI model according to an emotional state and a preference tendency of the user by adding condition information including the weighting parameters to the prompt sentence.

What is claimed is:

1. A system comprising:
circuitry configured to:
receive, via a communication interface coupled to a packet-switched network, item attribute data from a data source, and perform numerical processing and statistical processing on the item attribute data to generate distribution trend information stored in a storage device;
receive a query from a terminal device via the communication interface, tokenize a prompt sentence incorporating the distribution trend information and the query, transmit the tokenized prompt sentence to an inference engine executing a generative AI model, and decode an output token sequence from the inference engine to obtain a ranked result set; and
parse the ranked result set to extract record identifiers and relevance scores, and transmit the parsed result set to the terminal device via the communication interface.

2. The system according to claim 1, wherein the circuitry is configured to acquire item attribute data from a storage information source via the communication interface, convert the item attribute data into tabular data organized by time and attribute, and generate the distribution trend information representing statistical trends across the item attributes.

3. The system according to claim 2, wherein the circuitry is configured to generate the prompt sentence to include at least a subset of the tabular data, user attribute information received from the terminal device, and an instruction for the generative AI model to identify records matching the user attribute information and the distribution trends.

4. The system according to claim 3, wherein the circuitry is configured to parse the ranked result set received from the inference engine to extract record identifiers and relevance explanations, and generate a structured result for transmission to the terminal device.

5. The system according to claim 4, wherein the circuitry is configured to compute a relevance score for each record in the ranked result set by combining a distribution trend score derived from the distribution trend information with a preference match score derived from user preference information stored in the storage device.

6. The system according to claim 5, wherein the circuitry is configured to filter records in the ranked result set having a relevance score below a predetermined threshold, and retransmit the tokenized prompt sentence to the inference engine when a minimum number of qualifying records is not satisfied.

7. The system according to claim 1, wherein the circuitry is configured to receive, from the terminal device via the communication interface, body measurement data in addition to the query, and incorporate the body measurement data into the prompt sentence for the inference engine.

8. The system according to claim 7, wherein the circuitry is configured to generate a virtual fitting visualization by applying a visual representation of a record in the ranked result set to a body model generated from the body measurement data, and transmit the virtual fitting visualization to the terminal device via the communication interface.

9. The system according to claim 1, wherein the circuitry is configured to recognize an emotional state of the user based on data received from the terminal device via the communication interface, and adjust the parsed result set based on the recognized emotional state.

10. The system according to claim 9, wherein the circuitry is configured to modify at least one of a content selection criterion, a presentation style, and a ranking weight in the parsed result set based on the recognized emotional state of the user.

11. The system according to claim 1, wherein the circuitry is configured to collect feedback from the terminal device indicating whether records in the ranked result set were accepted or rejected by the user, update user preference information stored in the storage device based on the feedback, and incorporate the updated preference information into subsequent prompt sentences.

12. The system according to claim 11, wherein the circuitry is configured to update a user preference model stored in the storage device based on the collected feedback, and use the updated preference model when generating prompt sentences for subsequent queries.

13. The system according to claim 1, wherein the circuitry is configured to periodically update the distribution trend information by acquiring new item attribute data from the data source via the communication interface, and regenerate the statistical trend data for use in subsequent prompt sentences.

14. The system according to claim 1, wherein the circuitry is configured to apply subword segmentation to the prompt sentence prior to tokenization, encode the segmented prompt sentence using a vocabulary index of the generative AI model stored in the storage device, and configure inference parameters including temperature and maximum output length prior to transmission to the inference engine.

15. The system according to claim 14, wherein the circuitry is configured to decode the output token sequence from the inference engine using a decoding strategy stored in the storage device, obtain the ranked result set as a text string, and parse the text string to extract record identifiers and relevance explanations.

16. The system according to claim 1, wherein the circuitry is configured to generate a customization prompt sentence instructing the generative AI model to adapt the ranked result set based on user attribute information received from the terminal device, and incorporate the customization into the parsed result set transmitted to the terminal device.

17. The system according to claim 16, wherein the circuitry is configured to store the customization prompt sentence and the parsed result set in the storage device in association with a user identifier, and reuse the stored customization for personalized result sets in subsequent sessions.

18. A system comprising:
circuitry configured to:
receive, via a communication interface coupled to a packet-switched network, item attribute data from a data source, and perform statistical processing to generate distribution trend information stored in a storage device;
receive a query from a terminal device via the communication interface, tokenize a prompt sentence incorporating the distribution trend information and the query, transmit the tokenized prompt sentence to an inference engine executing a generative AI model, and decode an output token sequence to obtain a ranked result set;
parse the ranked result set to extract record identifiers and relevance scores, and adjust the parsed result set based on an emotional state of the user recognized from data received from the terminal device; and
transmit the adjusted parsed result set to the terminal device via the communication interface, and update user preference information stored in the storage device based on feedback received from the terminal device.

19. The system according to claim 18, wherein the circuitry is configured to compute a relevance score for each record in the ranked result set by combining a distribution trend score derived from the distribution trend information with a preference match score derived from the user preference information, and filter records below a predetermined threshold prior to transmission.

20. A method comprising:
receiving, via a communication interface coupled to a packet-switched network, item attribute data from a data source, and performing numerical processing and statistical processing on the item attribute data to generate distribution trend information stored in a storage device;
receiving a query from a terminal device via the communication interface, tokenizing a prompt sentence incorporating the distribution trend information and the query, transmitting the tokenized prompt sentence to an inference engine executing a generative AI model, and decoding an output token sequence from the inference engine to obtain a ranked result set; and
parsing the ranked result set to extract record identifiers and relevance scores, and transmitting the parsed result set to the terminal device via the communication interface.
